(19) United States
(12) Patent Application Publication
(10) Pub. No.: US 2026/0153877 A1
(43) Pub. Date: Jun. 4, 2026

(54) ROBOT MOVEMENT CONTROL METHOD AND ROBOT IMPLEMENTING SAME

(71) Applicant: LG ELECTRONICS INC., Seoul (KR)

(72) Inventors: Jaehark PARK, Seoul (KR); Sunwook BAE, Seoul (KR)

(73) Assignee: LG ELECTRONICS INC., Seoul (KR)

(21) Appl. No.: 19/123,048

(22) PCT Filed: Nov. 10, 2022
(86) PCT No.: PCT/KR2022/017633

§ 371 Date: Apr. 21, 2025

(51) Int. Cl. G05D 1/646

(52) U.S. Cl. CPC G05D 1/646

(57) ABSTRACT

The present disclosure relates to: a robot movement control method which enables a movement path to a target location to be quickly planned and/or movement to the target location to be quickly made; and a robot implementing same, and may provide a robot movement control method comprising the steps of: receiving information regarding a target location from a control server; searching for a partial trajectory corresponding to a narrow section required for a robot to move from the current location to the target location; planning, in a random tree method, a partial global path for a non-narrow section required for the robot to move from the current location to the target location; and generating a full global path for moving from the current location to the target location by using the partial trajectory and the partial global path.

### CROSS-REFERENCE TO RELATED APPLICATION(S)

This application is the National Stage filing under 35 U.S.C. 371 of International Application No. PCT/IB2023/062229, filed on Dec. 5, 2023, which claims the benefit of U.S. Provisional Application No. 63/425,291, filed on Nov. 14, 2022, the contents of which are all incorporated by reference herein in their entirety.

### TECHNICAL FIELD

The present disclosure relates to a wireless communication system.

### BACKGROUND

A variety of technologies, such as machine-to-machine (M2M) communication, machine type communication (MTC), and a variety of devices demanding high data throughput, such as smartphones and tablet personal computers (PCs), have emerged and spread. Accordingly, the volume of data throughput demanded to be processed in a cellular network has rapidly increased. In order to satisfy such rapidly increasing data throughput, carrier aggregation technology or cognitive radio technology for efficiently employing more frequency bands and multiple input multiple output (MIMO) technology or multi-base station (BS) cooperation technology for raising data capacity transmitted on limited frequency resources have been developed.

As more and more communication devices have required greater communication capacity, there has been a need for enhanced mobile broadband (eMBB) communication relative to legacy radio access technology (RAT). In addition, massive machine type communication (mMTC) for providing various services at anytime and anywhere by connecting a plurality of devices and objects to each other is one main issue to be considered in next-generation communication.

Communication system design considering services/user equipment (UEs) sensitive to reliability and latency is also under discussion. The introduction of next-generation RAT is being discussed in consideration of eMBB communication, mMTC, ultra-reliable and low-latency communication (URLLC), and the like.

### SUMMARY

A method capable of transmitting/receiving data packets with strict latency requirements and/or scheduling information for the data packets in a timely manner in a wireless communication system is required.

The objects to be achieved with the present disclosure are not limited to what has been particularly described hereinabove and other objects not described herein will be more clearly understood by persons skilled in the art from the following detailed description.

In an aspect of the present disclosure, provided herein is a method of receiving a downlink signal by a user equipment (UE) in a wireless communication system. The method includes: receiving a measurement gap configuration; and based on an overlap between a measurement gap according to the measurement gap configuration and a downlink reception occasion: i) based on specific conditions being not satisfied, performing measurements within the measurement gap and omitting downlink reception at the downlink reception occasion within the measurement gap; and ii) based on the specific conditions being satisfied, performing the downlink reception at a downlink reception occasion within the measurement gap.

In another aspect of the present disclosure, provided herein is a UE configured to receive a downlink signal in a wireless communication system. The UE includes: at least one transceiver; at least one processor; and at least one computer memory operably connected to the at least one processor and storing instructions that, when executed, cause the at least one processor to perform operations. The operations include: receiving a measurement gap configuration; and based on an overlap between a measurement gap according to the measurement gap configuration and a downlink reception occasion: i) based on specific conditions being not satisfied, performing measurements within the measurement gap and omitting downlink reception at the downlink reception occasion within the measurement gap; and ii) based on the specific conditions being satisfied, performing the downlink reception at a downlink reception occasion within the measurement gap.

In another aspect of the present disclosure, provided herein is a processing device. The processing device includes: at least one processor; and at least one computer memory operably connected to the at least one processor and storing instructions that, when executed, cause the at least one processor to perform operations. The operations include: receiving a measurement gap configuration; and based on an overlap between a measurement gap according to the measurement gap configuration and a downlink reception occasion: i) based on specific conditions being not satisfied, performing measurements within the measurement gap and omitting downlink reception at the downlink reception occasion within the measurement gap; and ii) based on the specific conditions being satisfied, performing the downlink reception at a downlink reception occasion within the measurement gap.

In another aspect of the present disclosure, provided herein is a computer-readable storage medium configured to store at least one program code including instructions that, when executed, cause at least one processor to perform operations. The operations include: receiving a measurement gap configuration; and based on an overlap between a measurement gap according to the measurement gap configuration and a downlink reception occasion: i) based on specific conditions being not satisfied, performing measurements within the measurement gap and omitting downlink reception at the downlink reception occasion within the measurement gap; and ii) based on the specific conditions being satisfied, performing the downlink reception at a downlink reception occasion within the measurement gap.

In another aspect of the present disclosure, provided herein is a method of transmitting, by a base station (BS), a downlink signal to a UE in a wireless communication system. The method includes: transmitting a measurement gap configuration; and based on an overlap between a measurement gap according to the measurement gap configuration and a downlink transmission occasion: i) based on specific conditions being not satisfied, omitting downlink transmission at the downlink transmission occasion within the measurement gap; and ii) based on that specific conditions being satisfied, performing the downlink transmission at the downlink transmission occasion within the measurement gap.

In another aspect of the present disclosure, provided herein is a BS configured to transmit a downlink signal to a UE in a wireless communication system. The BS includes: at least one transceiver; at least one processor; and at least one computer memory operably connected to the at least one processor and storing instructions that, when executed, cause the at least one processor to perform operations. The method includes: transmitting a measurement gap configuration; and based on an overlap between a measurement gap according to the measurement gap configuration and a downlink transmission occasion: i) based on specific conditions being not satisfied, omitting downlink transmission at the downlink transmission occasion within the measurement gap; and ii) based on the specific conditions being satisfied, performing the downlink transmission at the downlink transmission occasion within the measurement gap.

In another aspect of the present disclosure, provided herein is a processing device. The processing device includes: at least one processor; and at least one computer memory operably connected to the at least one processor and storing instructions that, when executed, cause the at least one processor to perform operations. The operations include: transmitting a measurement gap configuration; and based on an overlap between a measurement gap according to the measurement gap configuration and a downlink transmission occasion: i) based on specific conditions being not satisfied, omitting downlink transmission at the downlink transmission occasion within the measurement gap; and ii) based on the specific conditions being satisfied, performing the downlink transmission at the downlink transmission occasion within the measurement gap.

In another aspect of the present disclosure, provided herein is a computer-readable storage medium configured to store at least one program code including instructions that, when executed, cause at least one processor to perform operations. The operations include: transmitting a measurement gap configuration; and based on an overlap between a measurement gap according to the measurement gap configuration and a downlink transmission occasion: i) based on specific conditions being not satisfied, omitting downlink transmission at the downlink transmission occasion within the measurement gap; and ii) based on the specific conditions being satisfied, performing the downlink transmission at the downlink transmission occasion within the measurement gap.

In each aspect of the present disclosure, the specific conditions may include the following: the downlink reception/transmission occasion is a semi-persistent scheduling (SPS) physical downlink shared channel (PDSCH) occasion based on a specific SPS configuration, and the specific SPS configuration is an SPS configuration with a priority index greater than a threshold or an SPS configuration with a value allowing SPS PDSCH reception/transmission at an SPS PDSCH occasion when the SPS PDSCH occasion overlaps with the measurement gap.

In each aspect of the present disclosure, the specific conditions may include that the downlink reception/transmission occasion is a physical downlink control channel (PDCCH) occasion based on a search space or control resource set (CORESET) configuration including a specific radio resource control (RRC) parameter or a PDCCH monitoring/transmission occasion based on a search space configuration for a specific downlink control information format.

In each aspect of the present disclosure, the measurement gap configuration may include first priority information regarding scheduling based on downlink control information carried by a PDCCH and second priority information regarding scheduling based on RRC. The specific conditions may include: that, based on the downlink reception/transmission occasion being scheduled by a downlink control information format, a priority configured by the first priority information within the measurement gap configuration is smaller than a priority of the downlink reception/transmission; and that, based on the downlink reception/transmission occasion being scheduled by an RRC message, a priority configured by the second priority information within the measurement gap configuration is smaller than the priority of the downlink reception/transmission.

In each aspect of the present disclosure, the specific conditions may include: that the UE is waiting for downlink control information scheduling retransmission for a PDSCH or a physical uplink shared channel (PUSCH); and that the downlink reception/transmission occasion is a PDCCH monitoring occasion.

In each aspect of the present disclosure, the specific conditions may further include that a transport block carried by the PDSCH or the PUSCH has a packet data budget smaller than a specific threshold, is scheduled by a downlink control information format with a higher priority index value, or is based on an SPS configuration or a configured grant configuration.

In each aspect of the present disclosure, the specific conditions may include that the downlink reception/transmission occasion is scheduled by a downlink control information format with a higher priority index value, a downlink control information format indicating SPS activation, or a downlink control information format indicating the downlink reception/transmission.

The foregoing solutions are merely a part of the examples of the present disclosure and various examples into which the technical features of the present disclosure are incorporated may be derived and understood by persons skilled in the art from the following detailed description.

According to some implementations of the present disclosure, data packets with strict latency requirements and/or scheduling information for the data packets may be transmitted/received in a timely manner in a wireless communication system.

According to some implementations of the present disclosure, delay/latency that occurs during wireless communication between communication devices may be reduced.

The effects according to the present disclosure are not limited to what has been particularly described hereinabove and other effects not described herein will be more clearly understood by persons skilled in the art related to the present disclosure from the following detailed description.

### BRIEF DESCRIPTION OF THE DRAWINGS

The accompanying drawings, which are included to provide a further understanding of the present disclosure, illustrate examples of implementations of the present disclosure and together with the detailed description serve to explain implementations of the present disclosure:

FIG. 1 illustrates an example of a communication system 1 to which implementations of the present disclosure are applied;

FIG. 2 is a block diagram illustrating examples of communication devices capable of performing a method according to the present disclosure;

FIG. 3 illustrates another example of a wireless device capable of performing implementation(s) of the present disclosure;

FIG. 4 illustrates an example of a frame structure used in a 3rd generation partnership project (3GPP)-based wireless communication system;

FIG. 5 illustrates a resource grid of a slot;

FIG. 6 illustrates an example of physical downlink shared channel (PDSCH) time domain resource assignment (TDRA) caused by a physical downlink control channel (PDCCH) and an example of physical uplink shared channel (PUSCH) TDRA caused by the PDCCH;

FIG. 7 illustrates a hybrid automatic repeat request-acknowledgement (HARQ-ACK) transmission/reception procedure;

FIG. 8 illustrates a flow of a user equipment (UE) operation to which some implementations of the present disclosure are applicable;

FIG. 9 illustrates a flow of a base station (BS) operation to which some implementations of the present disclosure are applicable.

### DETAILED DESCRIPTION

Hereinafter, implementations according to the present disclosure will be described in detail with reference to the accompanying drawings. The detailed description, which will be given below with reference to the accompanying drawings, is intended to explain exemplary implementations of the present disclosure, rather than to show the only implementations that may be implemented according to the present disclosure. The following detailed description includes specific details in order to provide a thorough understanding of the present disclosure. However, it will be apparent to those skilled in the art that the present disclosure may be practiced without such specific details.

In some instances, known structures and devices may be omitted or may be shown in block diagram form, focusing on important features of the structures and devices, so as not to obscure the concept of the present disclosure. The same reference numbers will be used throughout the present disclosure to refer to the same or like parts.

A technique, a device, and a system described below may be applied to a variety of wireless multiple access systems. The multiple access systems may include, for example, a code division multiple access (CDMA) system, a frequency division multiple access (FDMA) system, a time division multiple access (TDMA) system, an orthogonal frequency division multiple access (OFDMA) system, a single-carrier frequency division multiple access (SC-FDMA) system, a multi-carrier frequency division multiple access (MC-FDMA) system, etc. CDMA may be implemented by radio technology such as universal terrestrial radio access (UTRA) or CDMA2000. TDMA may be implemented by radio technology such as global system for mobile communications (GSM), general packet radio service (GPRS), enhanced data rates for GSM evolution (EDGE) (i.e., GERAN), etc. OFDMA may be implemented by radio technology such as institute of electrical and electronics engineers (IEEE) 802.11 (Wi-Fi), IEEE 802.16 (WiMAX), IEEE 802.20, evolved-UTRA (E-UTRA), etc. UTRA is part of universal mobile telecommunications system (UMTS) and 3rd generation partnership project (3GPP) long-term evolution (LTE) is part of E-UMTS using E-UTRA. 3GPP LTE adopts OFDMA on downlink (DL) and adopts SC-FDMA on uplink (UL). LTE-advanced (LTE-A) is an evolved version of 3GPP LTE.

For convenience of description, description will be given under the assumption that the present disclosure is applied to LTE and/or new RAT (NR). However, the technical features of the present disclosure are not limited thereto. For example, although the following detailed description is given based on mobile communication systems corresponding to 3GPP LTE/NR systems, the mobile communication systems are applicable to other arbitrary mobile communication systems except for matters that are specific to the 3GPP LTE/NR system.

For terms and techniques that are not described in detail among terms and techniques used in the present disclosure, reference may be made to 3GPP based standard specifications, for example, 3GPP TS 36.211, 3GPP TS 36.212, 3GPP TS 36.213, 3GPP TS 36.321, 3GPP TS 36.300, 3GPP TS 36.331, 3GPP TS 37.213, 3GPP TS 38.211, 3GPP TS 38.212, 3GPP TS 38.213, 3GPP TS 38.214, 3GPP TS 38.300, 3GPP TS 38.321, 3GPP TS 38.331, etc.

In examples of the present disclosure described later, if a device “assumes” something, this may mean that a channel transmission entity transmits a channel in compliance with the corresponding “assumption.” This also may mean that a channel reception entity receives or decodes the channel in the form of conforming to the “assumption” on the premise that the channel has been transmitted in compliance with the “assumption.”

In the present disclosure, a user equipment (UE) may be fixed or mobile. Each of various devices that transmit and/or receive user data and/or control information by communicating with a base station (BS) may be the UE. The term UE may be referred to as terminal equipment, mobile station (MS), mobile terminal (MT), user terminal (UT), subscriber station (SS), wireless device, personal digital assistant (PDA), wireless modem, handheld device, etc. In the present disclosure, a BS refers to a fixed station that communicates with a UE and/or another BS and exchanges data and control information with a UE and another BS. The term BS may be referred to as advanced base station (ABS), Node-B (NB), evolved Node-B (eNB), base transceiver system (BTS), access point (AP), processing server (PS), etc. Particularly, a BS of a universal terrestrial radio access (UTRAN) is referred to as an NB, a BS of an evolved-UTRAN (E-UTRAN) is referred to as an eNB, and a BS of new radio access technology network is referred to as a gNB. Hereinbelow, for convenience of description, the NB, eNB, or gNB will be referred to as a BS regardless of the type or version of communication technology.

In the present disclosure, a node refers to a fixed point capable of transmitting/receiving a radio signal to/from a UE by communication with the UE. Various types of BSs may be used as nodes regardless of the names thereof. For example, a BS, NB, eNB, pico-cell eNB (PeNB), home eNB (HeNB), relay, repeater, etc. may be a node. Furthermore, a node may not be a BS. For example, a radio remote head (RRH) or a radio remote unit (RRU) may be a node. Generally, the RRH and RRU have power levels lower than that of the BS. Since the RRH or RRU (hereinafter, RRH/RRU) is connected to the BS through a dedicated line such as an optical cable in general, cooperative communication according to the RRH/RRU and the BS may be smoothly performed relative to cooperative communication according to BSs connected through a wireless link. At least one antenna is installed per node. An antenna may refer to a physical antenna port or refer to a virtual antenna or an antenna group. The node may also be called a point.

In the present disclosure, a cell refers to a specific geographical area in which one or more nodes provide communication services. Accordingly, in the present disclosure, communication with a specific cell may mean communication with a BS or a node providing communication services to the specific cell. A DL/UL signal of the specific cell refers to a DL/UL signal from/to the BS or the node providing communication services to the specific cell. A cell providing UL/DL communication services to a UE is especially called a serving cell. Furthermore, channel status/quality of the specific cell refers to channel status/quality of a channel or a communication link generated between the BS or the node providing communication services to the specific cell and the UE. In 3GPP-based communication systems, the UE may measure a DL channel state from a specific node using cell-specific reference signal(s) (CRS(s)) transmitted on a CRS resource and/or channel state information reference signal(s) (CSI-RS(s)) transmitted on a CSI-RS resource, allocated to the specific node by antenna port(s) of the specific node.

A 3GPP-based communication system uses the concept of a cell in order to manage radio resources, and a cell related with the radio resources is distinguished from a cell of a geographic area.

The “cell” of the geographic area may be understood as coverage within which a node may provide services using a carrier, and the “cell” of the radio resources is associated with bandwidth (BW), which is a frequency range configured by the carrier. Since DL coverage, which is a range within which the node is capable of transmitting a valid signal, and UL coverage, which is a range within which the node is capable of receiving the valid signal from the UE, depend upon a carrier carrying the signal, coverage of the node may also be associated with coverage of the “cell” of radio resources used by the node. Accordingly, the term “cell” may be used to indicate service coverage by the node sometimes, radio resources at other times, or a range that a signal using the radio resources may reach with valid strength at other times.

In 3GPP communication standards, the concept of the cell is used in order to manage radio resources. The “cell” associated with the radio resources is defined by a combination of DL resources and UL resources, that is, a combination of a DL component carrier (CC) and a UL CC. The cell may be configured by the DL resources only or by the combination of the DL resources and the UL resources. If carrier aggregation is supported, linkage between a carrier frequency of the DL resources (or DL CC) and a carrier frequency of the UL resources (or UL CC) may be indicated by system information. For example, the combination of the DL resources and the UL resources may be indicated by system information block type 2 (SIB2) linkage. In this case, the carrier frequency may be equal to or different from a center frequency of each cell or CC. When carrier aggregation (CA) is configured, the UE has only one radio resource control (RRC) connection with a network. During RRC connection establishment/re-establishment/handover, one serving cell provides non-access stratum (NAS) mobility information. During RRC connection re-establishment/handover, one serving cell provides security input. This cell is referred to as a primary cell (Pcell). The Pcell refers to a cell operating on a primary frequency on which the UE performs an initial connection establishment procedure or initiates a connection re-establishment procedure. According to UE capability, secondary cells (Scells) may be configured to form a set of serving cells together with the Pcell. The Scell may be configured after completion of RRC connection establishment and used to provide additional radio resources in addition to resources of a specific cell (SpCell). A carrier corresponding to the Pcell on DL is referred to as a downlink primary CC (DL PCC), and a carrier corresponding to the Pcell on UL is referred to as an uplink primary CC (UL PCC). A carrier corresponding to the Scell on DL is referred to as a downlink secondary CC (DL SCC), and a carrier corresponding to the Scell on UL is referred to as an uplink secondary CC (UL SCC).

In a dual connectivity (DC) operation, the term special cell (SpCell) refers to a Pcell of a master cell group (MCG) or a primary secondary cell (PSCell) of a secondary cell group (SCG). The SpCell supports PUCCH transmission and contention-based random access and is always activated. The MCG is a group of service cells associated with a master node (e.g., BS) and includes the SpCell (Pcell) and optionally one or more Scells. For a UE configured with DC, the SCG is a subset of serving cells associated with a secondary node and includes the PSCell and 0 or more Scells. The PSCell is a primary Scell of the SCG. For a UE in RRC_CONNECTED state, which is not configured with CA or DC, only one serving cell including only the Pcell is present. For a UE in RRC_CONNECTED state, which is configured with CA or DC, the term serving cells refers to a set of cells including SpCell(s) and all Scell(s). In DC, two medium access control (MAC) entities, i.e., one MAC entity for the MCG and one MAC entity for the SCG, are configured for the UE.

For a UE that is configured with CA and is not configured with DC, a Pcell PUCCH group (also called a primary PUCCH group) including the Pcell and 0 or more Scells and an Scell PUCCH group (also called a secondary PUCCH group) including only Scell(s) may be configured. For the Scell, an Scell on which a PUCCH associated with the corresponding cell is transmitted (hereinafter, a PUCCH cell) may be configured. An Scell for which a PUCCH Scell is indicated belongs to the Scell PUCCH group (i.e., the secondary PUCCH group) and PUCCH transmission of related uplink control information (UCI) is performed on the PUCCH Scell. If a PUCCH Scell is not indicated for an Scell or a cell which is indicated for PUCCH transmission for the Scell is a Pcell, the Scell belongs to the Pcell PUCCH group (i.e., the primary PUCCH group) and PUCCH transmission of related UCI is performed on the Pcell. Hereinbelow, if the UE is configured with the SCG and some implementations of the present disclosure related to a PUCCH are applied to the SCG, the primary cell may refer to the PSCell of the SCG. If the UE is configured with the PUCCH Scell and some implementations of the present disclosure related to the PUCCH are applied to the secondary PUCCH group, the primary cell may refer to the PUCCH Scell of the secondary PUCCH group.

In a wireless communication system, the UE receives information on DL from the BS and the UE transmits information on UL to the BS. The information that the BS and UE transmit and/or receive includes data and a variety of control information and there are various physical channels according to types/usage of the information that the UE and the BS transmit and/or receive.

The 3GPP-based communication standards define DL physical channels corresponding to resource elements carrying information originating from a higher layer and DL physical signals corresponding to resource elements which are used by the physical layer but do not carry the information originating from the higher layer. For example, a physical downlink shared channel (PDSCH), a physical broadcast channel (PBCH), a physical multicast channel (PMCH), a physical control format indicator channel (PCFICH), a physical downlink control channel (PDCCH), etc. are defined as the DL physical channels, and a reference signal (RS) and a synchronization signal (SS) are defined as the DL physical signals. The RS, which is also referred to as a pilot, represents a signal with a predefined special waveform known to both the BS and the UE. For example, a demodulation reference signal (DMRS), a channel state information RS (CSI-RS), etc. are defined as DL RSs. The 3GPP-based communication standards define UL physical channels corresponding to resource elements carrying information originating from the higher layer and UL physical signals corresponding to resource elements which are used by the physical layer but do not carry the information originating from the higher layer. For example, a physical uplink shared channel (PUSCH), a physical uplink control channel (PUCCH), and a physical random access channel (PRACH) are defined as the UL physical channels, and a DMRS for a UL control/data signal, a sounding reference signal (SRS) used for UL channel measurement, etc. are defined.

In the present disclosure, a PDCCH refers to a set of time-frequency resources (e.g., resource elements (REs)) carrying downlink control information (DCI), and a PDSCH refers to a set of time-frequency resources carrying DL data. A PUCCH, a PUSCH, and a PRACH refer to a set of time-frequency resources carrying UCI, a set of time-frequency resources carrying UL data, and a set of time-frequency resources carrying random access signals, respectively. In the following description, “the UE transmits/receives a PUCCH/PUSCH/PRACH” is used as the same meaning that the UE transmits/receives the UCI/UL data/random access signals on or through the PUCCH/PUSCH/PRACH, respectively. In addition, “the BS transmits/receives a PBCH/PDCCH/PDSCH” is used as the same meaning that the BS transmits the broadcast information/DCI/DL data on or through a PBCH/PDCCH/PDSCH, respectively.

In this specification, a radio resource (e.g., a time-frequency resource) scheduled or configured to the UE by the BS for transmission or reception of the PUCCH/PUSCH/PDSCH may be referred to as a PUCCH/PUSCH/PDSCH resource.

Since a communication device receives a synchronization signal block (SSB), DMRS, CSI-RS, PBCH, PDCCH, PDSCH, PUSCH, and/or PUCCH in the form of radio signals on a cell, the communication device may not select and receive radio signals including only a specific physical channel or a specific physical signal through a radio frequency (RF) receiver, or may not select and receive radio signals without a specific physical channel or a specific physical signal through the RF receiver. In actual operations, the communication device receives radio signals on the cell via the RF receiver, converts the radio signals, which are RF band signals, into baseband signals, and then decodes physical signals and/or physical channels in the baseband signals using one or more processors. Thus, in some implementations of the present disclosure, not receiving physical signals and/or physical channels may mean that a communication device does not attempt to restore the physical signals and/or physical channels from radio signals, for example, does not attempt to decode the physical signals and/or physical channels, rather than that the communication device does not actually receive the radio signals including the corresponding physical signals and/or physical channels.

As more and more communication devices have required greater communication capacity, there has been a need for eMBB communication relative to legacy radio access technology (RAT). In addition, massive MTC for providing various services at anytime and anywhere by connecting a plurality of devices and objects to each other is one main issue to be considered in next-generation communication. Further, communication system design considering services/UEs sensitive to reliability and latency is also under discussion. The introduction of next-generation RAT is being discussed in consideration of eMBB communication, massive MTC, ultra-reliable and low-latency communication (URLLC), and the like. Currently, in 3GPP, a study on the next-generation mobile communication systems after EPC is being conducted. In the present disclosure, for convenience, the corresponding technology is referred to as a new RAT (NR) or fifth-generation (5G) RAT, and a system using NR or supporting NR is referred to as an NR system.

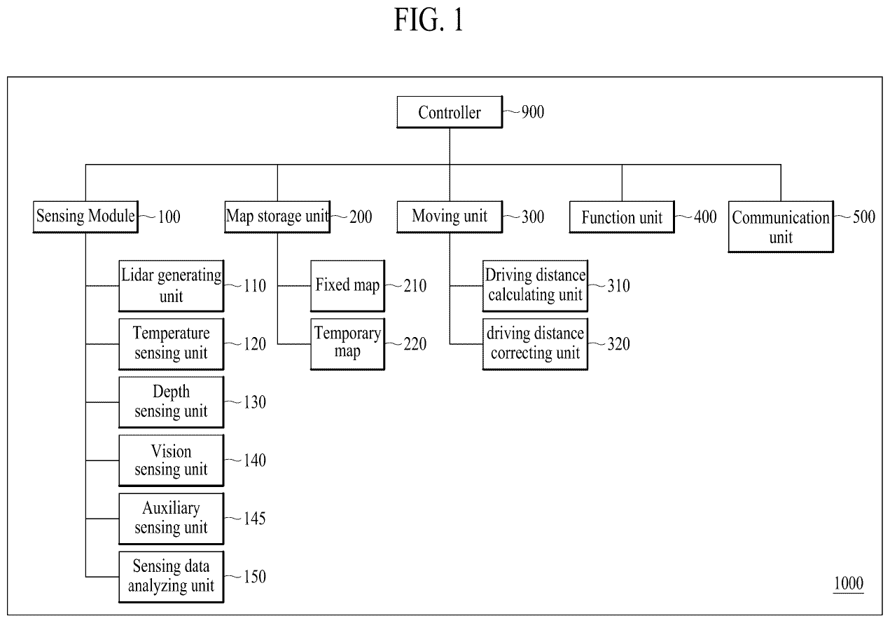

FIG. 1 illustrates an example of a communication system 1 to which implementations of the present disclosure are applied. Referring to FIG. 1, the communication system 1 applied to the present disclosure includes wireless devices, BSs, and a network. Here, the wireless devices represent devices performing communication using RAT (e.g., 5G NR or LTE (e.g., E-UTRA)) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of Things (IoT) device 100f, and an artificial intelligence (AI) device/server 400. For example, the vehicles may include a vehicle having a wireless communication function, an autonomous driving vehicle, and a vehicle capable of performing vehicle-to-vehicle communication. Here, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or smartglasses), and a computer (e.g., a notebook). The home appliance may include a TV, a refrigerator, and a washing machine. The IoT device may include a sensor and a smartmeter. For example, the BSs and the network may also be implemented as wireless devices and a specific wireless device may operate as a BS/network node with respect to another wireless device.

The wireless devices 100a to 100f may be connected to a network 300 via BSs 200. AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., vehicle-to-vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a and 150b may be established between the wireless devices 100a to 100f and the BSs 200 and between the wireless devices 100a to 100f). Here, the wireless communication/connections such as UL/DL communication 150a and sidelink communication 150b (or, device-to-device (D2D) communication) may be established by various RATs (e.g., 5G NR). The wireless devices and the BSs/wireless devices may transmit/receive radio signals to/from each other through the wireless communication/connections 150a and 150b. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

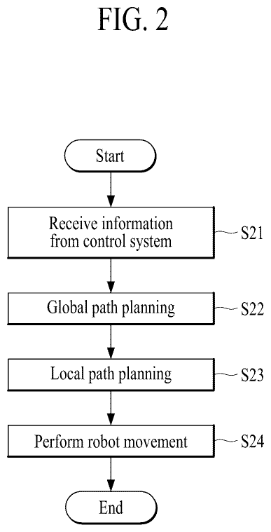

FIG. 2 is a block diagram illustrating examples of communication devices capable of performing a method according to the present disclosure. Referring to FIG. 2, a first wireless device 100 and a second wireless device 200 may transmit and/or receive radio signals through a variety of RATs (e.g., LTE and NR). Here, {the first wireless device 100 and the second wireless device 200} may correspond to {the wireless device 100x and the BS 200} and/or {the wireless device 100x and the wireless device 100x} of FIG. 1.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the below-described/proposed functions, procedures, and/or methods. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver(s) 106 and then store information obtained by processing the second information/signals in the memory(s) 104. The memory(s) 104 may be connected to the processor(s) 102 and may store a variety of information related to operations of the processor(s) 102. For example, the memory(s) 104 may perform a part or all of processes controlled by the processor(s) 102 or store software code including instructions for performing the below-described/proposed procedures and/or methods. Here, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 is used interchangeably with radio frequency (RF) unit(s). In the present disclosure, the wireless device may represent the communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the below-described/proposed functions, procedures, and/or methods. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may perform a part or all of processes controlled by the processor(s) 202 or store software code including instructions for performing the below-described/proposed procedures and/or methods. Here, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 is used interchangeably with RF unit(s). In the present disclosure, the wireless device may represent the communication modem/circuit/chip.

The wireless communication technology implemented in the wireless devices 100 and 200 of the present disclosure may include narrowband Internet of things for low-power communication as well as LTE, NR, and 6G. For example, the NB-IoT technology may be an example of low-power wide-area network (LPWAN) technologies and implemented in standards such as LTE Cat NB1 and/or LTE Cat NB2. However, the NB-IoT technology is not limited to the above names. Additionally or alternatively, the wireless communication technology implemented in the wireless devices XXX and YYY of the present disclosure may perform communication based on the LTE-M technology. For example, the LTE-M technology may be an example of LPWAN technologies and called by various names including enhanced machine type communication (eMTC). For example, the LTE-M technology may be implemented in at least one of the following various standards: 1) LTE CAT 0, 2) LTE Cat M1, 3) LTE Cat M2, 4) LTE non-Bandwidth Limited (non-BL), 5) LTE-MTC, 6) LTE Machine Type Communication, and/or 7) LTE M, etc., but the LTE-M technology is not limited to the above names. Additionally or alternatively, the wireless communication technology implemented in the wireless devices XXX and YYY of the present disclosure may include at least one of ZigBee, Bluetooth, and LPWAN in consideration of low-power communication, but the wireless communication technology is not limited to the above names. For example, the ZigBee technology may create a personal area network (PAN) related to small/low-power digital communication based on various standards such as IEEE 802.15.4 and so on, and the ZigBee technology may be called by various names.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as a physical (PHY) layer, medium access control (MAC) layer, a radio link control (RLC) layer, a packet data convergence protocol (PDCP) layer, radio resource control (RRC) layer, and a service data adaptation protocol (SDAP) layer). The one or more processors 102 and 202 may generate one or more protocol data units (PDUs) and/or one or more service data units (SDUs) according to the functions, procedures, proposals, and/or methods disclosed in the present disclosure. The one or more processors 102 and 202 may generate messages, control information, data, or information according to the functions, procedures, proposals, and/or methods disclosed in the present disclosure. The one or more processors 102 and 202 may generate signals (e.g., baseband signals) including PDUs, SDUs, messages, control information, data, or information according to the functions, procedures, proposals, and/or methods disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the functions, procedures, proposals, and/or methods disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The functions, procedures, proposals, and/or methods disclosed in the present disclosure may be implemented using firmware or software, and the firmware or software may be configured to include the modules, procedures, or functions. Firmware or software configured to perform the functions, procedures, proposals, and/or methods disclosed in the present disclosure may be included in the one or more processors 102 and 202 or stored in the one or more memories 104 and 204 so as to be driven by the one or more processors 102 and 202. The functions, procedures, proposals, and/or methods disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, commands, and/or instructions. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208. The one or more transceivers 106 and 206 may be configured to transmit and receive user data, control information, and/or radio signals/channels, mentioned in the functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

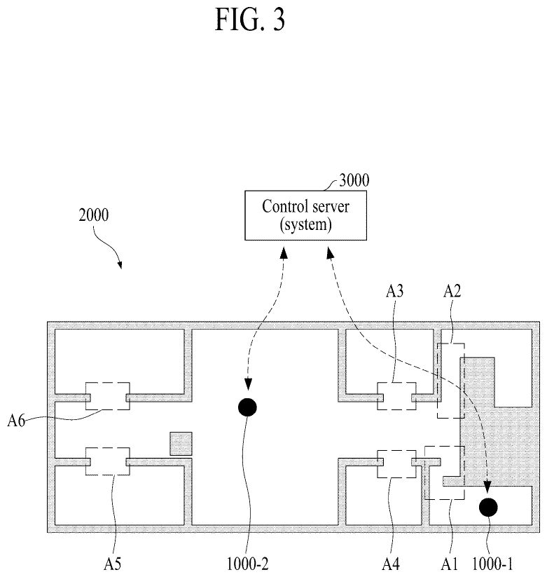

FIG. 3 illustrates another example of a wireless device capable of performing implementation(s) of the present disclosure. Referring to FIG. 3, wireless devices 100 and 200 may correspond to the wireless devices 100 and 200 of FIG. 2 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 2. For example, the transceiver(s) 114 may include the one or more transceivers 106 and 206 and/or the one or more antennas 108 and 208 of FIG. 2. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 1), the vehicles (100b-1 and 100b-2 of FIG. 1), the XR device (100c of FIG. 1), the hand-held device (100d of FIG. 1), the home appliance (100e of FIG. 1), the IoT device (100f of FIG. 1), a digital broadcast UE, a hologram device, a public safety device, an MTC device, a medicine device, a fintech device (or a finance device), a security device, a climate/environment device, the AI server/device (400 of FIG. 1), the BS (200 of FIG. 1), a network node, etc. The wireless device may be used in a mobile or fixed place according to a use-case/service.

In FIG. 3, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an electronic control unit (ECU), a graphical processing unit, and a memory control processor. As another example, the memory 130 may be configured by a random access memory (RAM), a dynamic RAM (DRAM), a read-only memory (ROM)), a flash memory, a transitory memory, a non-transitory memory, and/or a combination thereof.

In the present disclosure, the at least one memory (e.g., 104 or 204) may store instructions or programs, and the instructions or programs may cause, when executed, at least one processor operably connected to the at least one memory to perform operations according to some embodiments or implementations of the present disclosure.

In the present disclosure, a computer readable (non-transitory) storage medium may store at least one instruction or program, and the at least one instruction or program may cause, when executed by at least one processor, the at least one processor to perform operations according to some embodiments or implementations of the present disclosure.

In the present disclosure, a processing device or apparatus may include at least one processor, and at least one computer memory operably connected to the at least one processor. The at least one computer memory may store instructions or programs, and the instructions or programs may cause, when executed, the at least one processor operably connected to the at least one memory to perform operations according to some embodiments or implementations of the present disclosure.

In the present disclosure, a computer program may include program code stored on at least one computer-readable (non-transitory) storage medium and, when executed, configured to perform operations according to some implementations of the present disclosure or cause at least one processor to perform the operations according to some implementations of the present disclosure. The computer program may be provided in the form of a computer program product. The computer program product may include at least one computer-readable (non-transitory) storage medium.

A communication device of the present disclosure includes at least one processor; and at least one computer memory operably connected to the at least one processor and configured to store instructions for causing, when executed, the at least one processor to perform operations according to example(s) of the present disclosure described later.

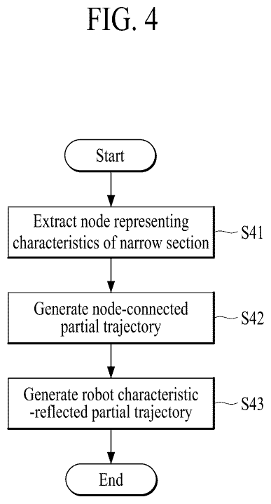

FIG. 4 illustrates an example of a frame structure used in a 3GPP-based wireless communication system.

The frame structure of FIG. 4 is purely exemplary and the number of subframes, the number of slots, and the number of symbols, in a frame, may be variously changed. In an NR system, different OFDM numerologies (e.g., subcarrier spacings (SCSs)) may be configured for multiple cells which are aggregated for one UE. Accordingly, the (absolute time) duration of a time resource including the same number of symbols (e.g., a subframe, a slot, or a transmission time interval (TTI)) may be differently configured for the aggregated cells. Here, the symbol may include an OFDM symbol (or cyclic prefix-OFDM (CP-OFDM) symbol) and an SC-FDMA symbol (or discrete Fourier transform-spread-OFDM (DFT-s-OFDM) symbol). In the present disclosure, the symbol, the OFDM-based symbol, the OFDM symbol, the CP-OFDM symbol, and the DFT-s-OFDM symbol are used interchangeably.

Referring to FIG. 4, in the NR system, UL and DL transmissions are organized into frames. Each frame has a duration of T_{f}=(Δfₘₐₓ*N_{f}/100)*T_{c}=10 ms and is divided into two half-frames of 5 ms each. A basic time unit for NR is T_{c}=1/(Δfₘₐₓ*N_{f}) where Δfₘₐₓ=480*10³ Hz and N_{f}=4096. For reference, a basic time unit for LTE is Tₛ=1/(Δf_{ref}*N_{f,ref}) where Δf_{ref}=15*10³ Hz and N_{f,ref}=2048. T_{c} and T_{f} have the relationship of a constant κ=T_{c}/T_{f}=64. Each half-frame includes 5 subframes and a duration T_{sf} of a single subframe is 1 ms. Subframes are further divided into slots and the number of slots in a subframe depends on a subcarrier spacing. Each slot includes 14 or 12 OFDM symbols based on a cyclic prefix. In a normal CP, each slot includes 14 OFDM symbols and, in an extended CP, each slot includes 12 OFDM symbols. The numerology depends on an exponentially scalable subcarrier spacing Δf=2^{μ}*15 kHz. The table below shows the number of OFDM symbols (N^{slot}_{symb}) per slot, the number of slots (N^{frame,μ}ₛₗₒₜ) per frame, and the number of slots (N^{subframe,μ}ₛₗₒₜ) per subframe.

TABLE 1

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The table below shows the number of OFDM symbols per slot, the number of slots per frame, and the number of slots per subframe, according to the subcarrier spacing Δf=2u*15 kHz.

TABLE 2

| u | N^{slot}_{symb} | N^{frame, u}ₛₗₒₜ | N^{subframe, u}ₛₗₒₜ |
|---|---|---|---|
| 2 | 12 | 40 | 4 |

For a subcarrier spacing configuration u, slots may be indexed within a subframe in ascending order as follows: n^{u}ₛ∈{0, . . . , n^{subframe,u}ₛₗₒₜ−1} and indexed within a frame in ascending order as follows: n^{u}_{s,f}∈{0, . . . , n^{frame,u}ₛₗₒₜ−1}.

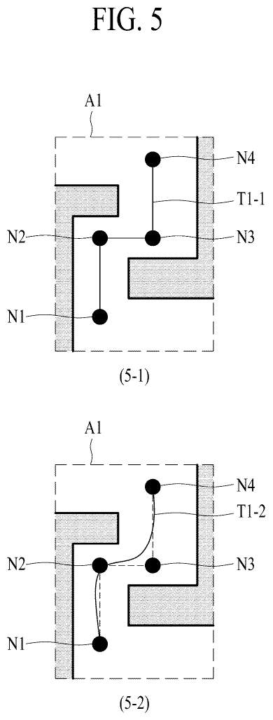

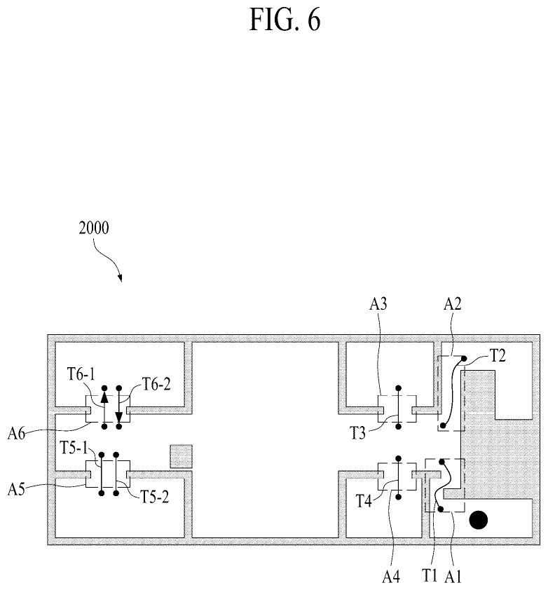

FIG. 5 illustrates a resource grid of a slot. The slot includes multiple (e.g., 14 or 12) symbols in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at a common resource block (CRB) N^{start,u}_{grid} indicated by higher layer signaling (e.g. RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP-based wireless communication system, N^{RB}_{sc} is typically 12. There is one resource grid for a given antenna port p, a subcarrier spacing configuration u, and a transmission link (DL or UL). The carrier bandwidth N^{size,u}_{grid} for the subcarrier spacing configuration u is given to the UE by a higher layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index/representing a symbol location relative to a reference point in the time domain. In the NR system, an RB is defined by 12 consecutive subcarriers in the frequency domain. In the NR system, RBs are classified into CRBs and physical resource blocks (PRBs). The CRBs are numbered from 0 upwards in the frequency domain for the subcarrier spacing configuration w. The center of subcarrier 0 of CRB 0 for the subcarrier spacing configuration u is equal to ‘Point A’ which serves as a common reference point for RB grids. The PRBs for subcarrier spacing configuration u are defined within a bandwidth part (BWP) and numbered from 0 to N^{size,u}_{BWP,i}−1, where i is a number of the BWP. The relation between a PRB n_{PRB} in a BWP i and a CRB n^{u}_{CRB} is given by: n^{u}_{PRB}=n^{u}_{CRB}+N^{size,u}_{BWP,i}, where N^{size}_{BWP,i} is a CRB in which the BWP starts relative to CRB 0. The BWP includes a plurality of consecutive RBs in the frequency domain. For example, the BWP may be a subset of contiguous CRBs defined for a given numerology uᵢ in the BWP i on a given carrier. A carrier may include a maximum of N (e.g., 5) BWPs. The UE may be configured to have one or more BWPs on a given component carrier. Data communication is performed through an activated BWP and only a predetermined number of BWPs (e.g., one BWP) among BWPs configured for the UE may be active on the component carrier.

For each serving cell in a set of DL BWPs or UL BWPs, the network may configure at least an initial DL BWP and one (if the serving cell is configured with uplink) or two (if supplementary uplink is used) initial UL BWPs. The network may configure additional UL and DL BWPs. For each DL BWP or UL BWP, the UE may be provided the following parameters for the serving cell: i) an SCS; ii) a CP; iii) a CRB N^{start}_{BWP}=O_{carrier}+RBₛₜₐᵣₜ and the number of contiguous RBs N^{size}_{BWP}=L_{RB} provided by an RRC parameter locationAndBandwidth, which indicates an offset RBₛₑₜ and a length L_{RB} as a resource indicator value (RIV) on the assumption of N^{start}_{BWP}=275, and a value O_{carrier} provided by an RRC parameter offsetToCarrier for the SCS; an index in the set of DL BWPs or UL BWPs; a set of BWP-common parameters; and a set of BWP-dedicated parameters.

Virtual resource blocks (VRBs) may be defined within the BWP and indexed from 0 to N^{size,u}_{BWP,i}−1, where i denotes a BWP number. The VRBs may be mapped to PRBs according to interleaved mapping or non-interleaved mapping. In some implementations, VRB n may be mapped to PRB n for non-interleaved VRB-to-PRB mapping.

The UE for which carrier aggregation is configured may be configured to use one or more cells. If the UE is configured with a plurality of serving cells, the UE may be configured with one or multiple cell groups. The UE may also be configured with a plurality of cell groups associated with different BSs. Alternatively, the UE may be configured with a plurality of cell groups associated with a single BS. Each cell group of the UE includes one or more serving cells and includes a single PUCCH cell for which PUCCH resources are configured. The PUCCH cell may be a Pcell or an Scell configured as the PUCCH cell among Scells of a corresponding cell group. Each serving cell of the UE belongs to one of cell groups of the UE and does not belong to a plurality of cells.

NR frequency bands are defined as two types of frequency ranges, i.e., FR1 and FR2. FR2 is also referred to as millimeter wave (mmW). The following table shows frequency ranges within which NR may operate.

TABLE 3

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

Hereinafter, physical channels that may be used in the 3GPP-based wireless communication system will be described in detail.

A PDCCH carries DCI. For example, the PDCCH (i.e., DCI) carries information about transport format and resource allocation of a downlink shared channel (DL-SCH), information about resource allocation of an uplink shared channel (UL-SCH), paging information about a paging channel (PCH), system information about the DL-SCH, information about resource allocation for a control message, such as a random access response (RAR) transmitted on a PDSCH, of a layer (hereinafter, higher layer) positioned higher than a physical layer among protocol stacks of the UE/BS, a transmit power control command, information about activation/deactivation of configured scheduling (CS), etc. DCI including resource allocation information on the DL-SCH is called PDSCH scheduling DCI, and DCI including resource allocation information on the UL-SCH is called PUSCH scheduling DCI. The DCI includes a cyclic redundancy check (CRC). The CRC is masked/scrambled with various identifiers (e.g., radio network temporary identifier (RNTI)) according to an owner or usage of the PDCCH. For example, if the PDCCH is for a specific UE, the CRS is masked with a UE identifier (e.g., cell-RNTI (C-RNTI)). If the PDCCH is for a paging message, the CRC is masked with a paging RNTI (P-RNTI). If the PDCCH is for system information (e.g., system information block (SIB)), the CRC is masked with a system information RNTI (SI-RNTI). If the PDCCH is for a random access response, the CRC is masked with a random access-RNTI (RA-RNTI).

When a PDCCH on one serving cell schedules a PDSCH or a PUSCH on another serving cell, it is referred to cross-carrier scheduling. Cross-carrier scheduling with a carrier indicator field (CIF) may allow a PDCCH on a serving cell to schedule resources on another serving cell. When a PDSCH on a serving cell schedules a PDSCH or a PUSCH on the serving cell, it is referred to as self-carrier scheduling. When the cross-carrier scheduling is used in a cell, the BS may provide information about a cell scheduling the cell to the UE. For example, the BS may inform the UE whether a serving cell is scheduled by a PDCCH on another (scheduling) cell or scheduled by the serving cell. If the serving cell is scheduled by the other (scheduling) cell, the BS may inform the UE which cell signals DL assignments and UL grants for the serving cell. In the present disclosure, a cell carrying a PDCCH is referred to as a scheduling cell, and a cell where transmission of a PUSCH or a PDSCH is scheduled by DCI included in the PDCCH, that is, a cell carrying the PUSCH or PDSCH scheduled by the PDCCH is referred to as a scheduled cell.

A PDSCH is a physical layer UL channel for UL data transport. The PDSCH carries DL data (e.g., DL-SCH transport block) and is subjected to modulation such as quadrature phase shift keying (QPSK), 16 quadrature amplitude modulation (QAM), 64 QAM, 256 QAM, etc. A codeword is generated by encoding a transport block (TB). The PDSCH may carry a maximum of two codewords. Scrambling and modulation mapping per codeword may be performed and modulation symbols generated from each codeword may be mapped to one or more layers. Each layer is mapped to a radio resource together with a DMRS and generated as an OFDM symbol signal. Then, the OFDM symbol signal is transmitted through a corresponding antenna port.

A PUCCH is a physical layer UL channel for uplink control information (UCI) transmission. The PUCCH carries UCI. UCI types transmitted on the PUCCH include hybrid automatic repeat request acknowledgement (HARQ-ACK) information, a scheduling request (SR), and channel state information (CSI). UCI bits include HARQ-ACK information bits if present, SR information bits if present, link recovery request (LRR) information bits if present, and CSI bits if present. In the present disclosure, HARQ-ACK information bits correspond to a HARQ-ACK codebook. In particular, a bit sequence in which HARQ-ACK information bits are arranged according to a predetermined rule is called a HARQ-ACK codebook.
Scheduling request (SR): Information that is used to request a UL-SCH resource.
Hybrid automatic repeat request (HARQ)-acknowledgment (ACK): A response to a DL data packet (e.g., codeword) on the PDSCH. HARQ-ACK indicates whether the DL data packet has been successfully received by a communication device. In response to a single codeword, 1-bit HARQ-ACK may be transmitted. In response to two codewords, 2-bit HARQ-ACK may be transmitted. The HARQ-ACK response includes positive ACK (simply, ACK), negative ACK (NACK), discontinuous transmission (DTX), or NACK/DTX. Here, the term HARQ-ACK is used interchangeably with HARQ ACK/NACK, ACK/NACK, or A/N.
Channel state information (CSI): Feedback information about a DL channel. The CSI may include channel quality information (CQI), a rank indicator (RI), a precoding matrix indicator (PMI), a CSI-RS resource indicator (CRI), an SS/PBCH resource block indicator (SSBRI), and a layer indicator (L1). The CSI may be classified into CSI part 1 and CSI part 2 according to UCI type included in the CSI. For example, the CRI, RI, and/or the CQI for the first codeword may be included in CSI part 1, and L1, PMI, and/or the CQI for the second codeword may be included in CSI part 2.
Link recovery request (LRR)

In the present disclosure, for convenience, PUCCH resources configured/indicated for/to the UE by the BS for HARQ-ACK, SR, and CSI transmission are referred to as a HARQ-ACK PUCCH resource, an SR PUCCH resource, and a CSI PUCCH resource, respectively.

PUCCH formats may be defined as follows according to UCI payload sizes and/or transmission lengths (e.g., the number of symbols included in PUCCH resources). In regard to the PUCCH formats, reference may also be made to Table 4.

(0) PUCCH format 0 (PF0 or F0)
Supported UCI payload size: up to K bits (e.g., K=2)
Number of OFDM symbols constituting a single PUCCH: 1 to X symbols (e.g., X=2)
Transmission structure: Only a UCI signal without a DMRS is included in PUCCH format 0. The UE transmits a UCI state by selecting and transmitting one of a plurality of sequences. For example, the UE transmits specific UCI to the BS by transmitting one of a plurality of sequences through a PUCCH, which is PUCCH format 0. The UE transmits the PUCCH, which is PUCCH format 0, in PUCCH resources for a corresponding SR configuration only upon transmitting a positive SR.
Configuration for PUCCH format 0 includes the following parameters for a corresponding PUCCH resource: an index for initial cyclic shift, the number of symbols for PUCCH transmission, and/or the first symbol for PUCCH transmission.

### (1) PUCCH Format 1 (PF1 or F1)

Supported UCI payload size: up to K bits (e.g., K=2)
Number of OFDM symbols constituting a single PUCCH: Y to Z symbols (e.g., Y=4 and Z=14)
Transmission structure: The DMRS and UCI are configured/mapped in TDM in/to different OFDM symbols. In other words, the DMRS is transmitted in symbols in which modulation symbols are not transmitted and the UCI is represented as the product between a specific sequence (e.g., orthogonal cover code (OCC)) and a modulation (e.g., QPSK) symbol. Code division multiplexing (CDM) is supported between a plurality of PUCCH resources (conforming to PUCCH format 1) (within the same RB) by applying cyclic shifts (CSs)/OCCs to both the UCI and the DMRS. PUCCH format 1 carries the UCI of up to 2 bits and the modulation symbols are spread by the OCC (differently configured depending on whether frequency hopping is performed) in the time domain.
Configuration for PUCCH format 1 includes the following parameters for a corresponding PUCCH resource: an index for initial cyclic shift, the number of symbols for PUCCH transmission, the first symbol for PUCCH transmission, and/or an index for the OCC.

### (2) PUCCH Format 2 (PF2 or F2)

Supported UCI payload size: more than K bits (e.g., K=2)
Number of OFDM symbols constituting a single PUCCH: 1 to X symbols (e.g., X=2)
Transmission structure: The DMRS and UCI are configured/mapped using frequency division multiplexing (FDM) within the same symbol. The UE transmits the UCI by applying only IFFT without DFT to encoded UCI bits. PUCCH format 2 carries UCI of a larger bit size than K bits and modulation symbols are subjected to FDM with the DMRS, for transmission. For example, the DMRS is located in symbol indexes #1, #4, #7, and #10 within a given RB with the density of ⅓. A pseudo noise (PN) sequence is used for a DMRS sequence. Frequency hopping may be activated for 2-symbol PUCCH format 2.
Configuration for PUCCH format 2 includes the following parameters for a corresponding PUCCH resource: the number of PRBs, the number of symbols for PUCCH transmission, and/or the first symbol for PUCCH transmission.

### (3) PUCCH Format 3 (PF3 or F3)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. The UE transmits the UCI by applying DFT to encoded UCI bits. PUCCH format 3 does not support UE multiplexing for the same time-frequency resource (e.g., same PRB).

Configuration for PUCCH format 3 includes the following parameters for a corresponding PUCCH resource: the number of PRBs, the number of symbols for PUCCH transmission, and/or the first symbol for PUCCH transmission.

### (4) PUCCH Format 4 (PF4 or F4)

Supported UCI payload size: more than K bits (e.g., K=2)
Number of OFDM symbols constituting a single PUCCH: Y to Z symbols (e.g., Y=4 and Z=14)
Transmission structure: The DMRS and UCI are configured/mapped in TDM for/to different OFDM symbols. PUCCH format 4 may multiplex up to 4 UEs in the same PRB, by applying an OCC at the front end of DFT and applying a CS (or interleaved FDM (IFDM) mapping) to the DMRS. In other words, modulation symbols of the UCI are subjected to TDM with the DMRS, for transmission.
Configuration for PUCCH format 4 includes the following parameters for a corresponding PUCCH resource: the number of symbols for PUCCH transmission, length for the OCC, an index for the OCC, and the first symbol for PUCCH transmission.

The table below shows the PUCCH formats. The PUCCH formats may be divided into short PUCCH formats (formats 0 and 2) and long PUCCH formats (formats 1, 3, and 4) according to PUCCH transmission length.

TABLE 4

| | Length in | | | |
|---|---|---|---|---|
| | OFDM | | | |
| PUCCH | symbols | Number | | |
| format | N^{PUCCH}_{symb} | of bits | Usage | Etc. |
| 0 | 1-2 | =<2 | HARQ, SR | Sequence |
| | | | | selection |
| 1 | 4-14 | =<2 | HARQ, [SR] | Sequence |
| | | | | modulation |
| 2 | 1-2 | >2 | HARQ, CSI, [SR] | CP-OFDM |
| 3 | 4-14 | >2 | HARQ, CSI, [SR] | DFT-s-OFDM(no |
| | | | | UE multiplexing) |
| 4 | 4-14 | >2 | HARQ, CSI, [SR] | DFT-s-OFDM(Pre |
| | | | | DFT OCC) |

A PUCCH resource may be determined according to a UCI type (e.g., A/N, SR, or CSI). A PUCCH resource used for UCI transmission may be determined based on a UCI (payload) size. For example, the BS may configure a plurality of PUCCH resource sets for the UE, and the UE may select a specific PUCCH resource set corresponding to a specific range according to the range of the UCI (payload) size (e.g., numbers of UCI bits). For example, the UE may select one of the following PUCCH resource sets according to the number of UCI bits, N_{UCI}.
PUCCH resource set #0, if the number of UCI bits=<2
PUCCH resource set #1, if 2<the number of UCI bits=<N₁
. . .
PUCCH resource set #(K−1), if N_{K-2}<the number of UCI bits=<N_{K-1}

Here, K represents the number of PUCCH resource sets (K>1) and Nᵢ represents a maximum number of UCI bits supported by PUCCH resource set #i. For example, PUCCH resource set #1 may include resources of PUCCH formats 0 to 1, and the other PUCCH resource sets may include resources of PUCCH formats 2 to 4 (see Table 4).

Configuration for each PUCCH resource includes a PUCCH resource index, a start PRB index, and configuration for one of PUCCH format 0 to PUCCH format 4. The UE is configured with a code rate for multiplexing HARQ-ACK, SR, and CSI report(s) within PUCCH transmission using PUCCH format 2, PUCCH format 3, or PUCCH format 4, by the BS through a higher layer parameter maxCodeRate. The higher layer parameter maxCodeRate is used to determine how to feed back the UCI on PUCCH resources for PUCCH format 2, 3, or 4.

If the UCI type is SR and CSI, a PUCCH resource to be used for UCI transmission in a PUCCH resource set may be configured for the UE through higher layer signaling (e.g., RRC signaling). If the UCI type is HARQ-ACK for a semi-persistent scheduling (SPS) PDSCH, the PUCCH resource to be used for UCI transmission in the PUCCH resource set may be configured for the UE through higher layer signaling (e.g., RRC signaling). On the other hand, if the UCI type is HARQ-ACK for a PDSCH scheduled by DCI, the PUCCH resource to be used for UCI transmission in the PUCCH resource set may be scheduled by the DCI.

In the case of DCI-based PUCCH resource scheduling, the BS may transmit the DCI to the UE on a PDCCH and indicate a PUCCH resource to be used for UCI transmission in a specific PUCCH resource set by an ACK/NACK resource indicator (ARI) in the DCI. The ARI may be used to indicate a PUCCH resource for ACK/NACK transmission and also be referred to as a PUCCH resource indicator (PRI). Here, the DCI may be used for PDSCH scheduling and the UCI may include HARQ-ACK for a PDSCH. The BS may configure a PUCCH resource set including a larger number of PUCCH resources than states representable by the ARI by (UE-specific) higher layer (e.g., RRC) signaling for the UE. The ARI may indicate a PUCCH resource subset of the PUCCH resource set and which PUCCH resource in the indicated PUCCH resource subset is to be used may be determined according to an implicit rule based on transmission resource information about the PDCCH (e.g., the starting CCE index of the PDCCH).

For UL-SCH data transmission, the UE should include UL resources available for the UE and, for DL-SCH data reception, the UE should include DL resources available for the UE. The UL resources and the DL resources are assigned to the UE by the BS through resource allocation. Resource allocation may include time domain resource allocation (TDRA) and frequency domain resource allocation (FDRA). In the present disclosure, UL resource allocation is also referred to as a UL grant and DL resource allocation is referred to as DL assignment. The UL grant is dynamically received by the UE on the PDCCH or in RAR or semi-persistently configured for the UE by the BS through RRC signaling. DL assignment is dynamically received by the UE on the PDCCH or semi-persistently configured for the UE by the BS through RRC signaling.

On UL, the BS may dynamically allocate UL resources to the UE through PDCCH(s) addressed to a cell radio network temporary Identifier (C-RNTI). The UE monitors the PDCCH(s) in order to discover possible UL grant(s) for UL transmission. The BS may allocate the UL resources using a configured grant to the UE. Two types of configured grants, Type 1 and Type 2, may be used. In Type 1, the BS directly provides the configured UL grant (including periodicity) through RRC signaling. In Type 2, the BS may configure a periodicity of an RRC-configured UL grant through RRC signaling and signal, activate, or deactivate the configured UL grant through the PDCCH addressed to a configured scheduling RNTI (CS-RNTI). For example, in Type 2, the PDCCH addressed to the CS-RNTI indicates that the corresponding UL grant may be implicitly reused according to the configured periodicity through RRC signaling until deactivation.

On DL, the BS may dynamically allocate DL resources to the UE through PDCCH(s) addressed to the C-RNTI. The UE monitors the PDCCH(s) in order to discover possible DL grant(s). The BS may allocate the DL resources to the UE using SPS. The BS may configure a periodicity of configured DL assignment through RRC signaling and signal, activate, or deactivate the configured DL assignment through the PDCCH addressed to the CS-RNTI. For example, the PDCCH addressed to the CS-RNTI indicates that the corresponding DL assignment may be implicitly reused according to the configured periodicity through RRC signaling until deactivation.

Hereinafter, resource allocation by the PDCCH and resource allocation by RRC will be described in more detail.

### Resource Allocation by PDCCH: Dynamic Grant/Assignment

The PDCCH may be used to schedule DL transmission on the PDSCH and UL transmission on the PUSCH. DCI on the PDCCH for scheduling DL transmission may include DL resource assignment that at least includes a modulation and coding format (e.g., modulation and coding scheme (MCS)) index I_{MCS}), resource allocation, and HARQ information, associated with a DL-SCH. DCI on the PDCCH for scheduling UL transmission may include a UL scheduling grant that at least includes a modulation and coding format, resource allocation, and HARQ information, associated with a UL-SCH. HARQ information on a DL-SCH or UL-SCH may include a new information indicator (NDI), transport block size (TBS), redundancy version (RV), and HARQ process ID (i.e., HARQ process number). The size and usage of the DCI carried by one PDCCH differs according to a DCI format. For example, DCI format 0_0, DCI format 0_1, or DCI format 0_2 may be used to schedule the PUSCH, and DCI format 1_0, DCI format 1_1, or DCI format 1_2 may be used to schedule the PDSCH. Particularly, DCI format 0_2 and DCI format 1_2 may be used to schedule transmission having higher transmission reliability and lower latency requirements than transmission reliability and latency requirement guaranteed by DCI format 0_0, DCI format 0_1, DCI format 1_0, or DCI format 1_1. Some implementations of the present disclosure may be applied to UL data transmission based on DCL format 0_2. Some implementations of the present disclosure may be applied to DL data reception based on DCI format 1_2.

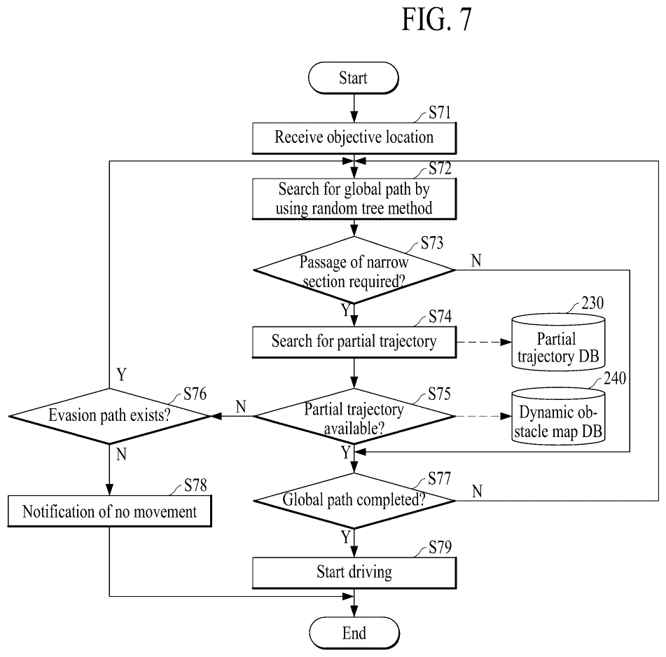

FIG. 7 illustrates an example of PDSCH TDRA caused by a PDCCH and an example of PUSCH TDRA caused by the PDCCH.

DCI carried by the PDCCH in order to schedule a PDSCH or a PUSCH includes a TDRA field. The TDRA field provides a value m for a row index m+1 to an allocation table for the PDSCH or the PUSCH. Predefined default PDSCH time domain allocation is applied as the allocation table for the PDSCH or a PDSCH TDRA table that the BS configures through RRC signaled pdsch-TimeDomainAllocationList is applied as the allocation table for the PDSCH. Predefined default PUSCH time domain allocation is applied as the allocation table for the PUSCH or a PUSCH TDRA table that the BS configures through RRC signaled pusch-TimeDomainAllocationList is applied as the allocation table for the PUSCH. The PDSCH TDRA table to be applied and/or the PUSCH TDRA table to be applied may be determined according a fixed/predefined rule (e.g., refer to 3GPP TS 38.214).

In PDSCH time domain resource configurations, each indexed row defines a DL assignment-to-PDSCH slot offset K₀, a start and length indicator value SLIV (or directly, a start position (e.g., start symbol index S) and an allocation length (e.g., the number of symbols, L) of the PDSCH in a slot), and a PDSCH mapping type. In PUSCH time domain resource configurations, each indexed row defines a UL grant-to-PUSCH slot offset K₂, a start position (e.g., start symbol index S) and an allocation length (e.g., the number of symbols, L) of the PUSCH in a slot, and a PUSCH mapping type. K₀ for the PDSCH and K₂ for the PUSCH indicate the difference between the slot with the PDCCH and the slot with the PDSCH or PUSCH corresponding to the PDCCH. SLIV denotes a joint indicator of the start symbol S relative to the start of the slot with the PDSCH or PUSCH and the number of consecutive symbols, L, counting from the symbol S. There are two PDSCH/PUSCH mapping types: one is mapping type A and the other is mapping type B. In the case of PDSCH/PUSCH mapping type A, a DMRS is mapped to a PDSCH/PUSCH resource with respect to the start of a slot. One or two of the symbols of the PDSCH/PUSCH resource may be used as DMRS symbol(s) according to other DMRS parameters. For example, in the case of PDSCH/PUSCH mapping type A, the DMRS is located in the third symbol (symbol #2) or the fourth symbol (symbol #3) in the slot according to RRC signaling. In the case of PDSCH/PUSCH mapping type B, a DMRS is mapped with respect to the first OFDM symbol of a PDSCH/PUSCH resource. One or two symbols from the first symbol of the PDSCH/PUSCH resource may be used as DMRS symbol(s) according to other DMRS parameters. For example, in the case of PDSCH/PUSCH mapping type B, the DMRS is located at the first symbol allocated for the PDSCH/PUSCH. In the present disclosure, the PDSCH/PUSCH mapping type may be referred to as a mapping type or a DMRS mapping type. For example, in the present disclosure, PUSCH mapping type A may be referred to as mapping type A or DMRS mapping type A, and PUSCH mapping type B may be referred to as mapping type B or DMRS mapping type B.

The scheduling DCI includes an FDRA field that provides assignment information about RBs used for the PDSCH or the PUSCH. For example, the FDRA field provides information about a cell for PDSCH or PUSCH transmission to the UE, information about a BWP for PDSCH or PUSCH transmission, and/or information about RBs for PDSCH or PUSCH transmission.

### Resource Allocation by RRC

As mentioned above, there are two types of transmission without dynamic grant: configured grant Type 1 and configured grant Type 2. In configured grant Type 1, a UL grant is provided by RRC and stored as a configured UL grant. In configured grant Type 2, the UL grant is provided by the PDCCH and stored or cleared as the configured UL grant based on L1 signaling indicating configured UL grant activation or deactivation. Type 1 and Type 2 may be configured by RRC per serving cell and per BWP. Multiple configurations may be active simultaneously on different serving cells.

When configured grant Type 1 is configured, the UE may be provided with the following parameters through RRC signaling:
cs-RNTI corresponding to a CS-RNTI for retransmission;
periodicity corresponding to a periodicity of configured grant Type 1;
timeReferenceSFN that indicates a system frame number (SFN) used for determination of an offset of a resource in time domain;
timeDomainOffset is an offset related to SFN indicated by timeReferenceSFN;
timeDomainAllocation value m that provides a row index m+1 pointing to the allocation table, indicating a combination of the start symbol S, the length L, and the PUSCH mapping type;
frequencyDomainAllocation that provides frequency domain resource allocation; and
mcsAndTBS that provides I_{MCS} indicating a modulation order, a target code rate, and a transport block size.

Upon configuration of configured grant Type 1 for a serving cell by RRC, the UE stores the UL grant provided by RRC as a configured UL grant for an indicated serving cell and initializes or re-initializes the configured UL grant to start in a symbol according to timeDomainOffset and S (derived from SLIV) and to recur with periodicity. After the UL grant is configured for configured grant Type 1, the UE may consider that the UL grant recurs in association with each symbol satisfying: [(SFN*memberOfSlotsPerFrame*memberOfSymbolsPerSlot+(slot number in the frame*memberOfSymbolsPerSlot)+symbol number in the slot]=(timeReferenceSFN memberOfSlotsPerFrame*numberOfSymbolsPerSlot+time DomainOffset*memberOfSymbolsPerSlot+S+N*periodicity) modulo (1024*memberOfSlotsPerFrame*memberOfSymbolsPerSlot), for N>=0, where numberOfSlotsPerFrame and memberOfSymbolsPerSlot indicate the number of consecutive slots per frame and the number of consecutive OFDM symbols per slot, respectively (refer to Table 1 and Table 2).

For configured grant Type 2, the UE may be provided with the following parameters by the BS through RRC signaling:
cs-RNTI corresponding to a CS-RNTI for activation, deactivation, and retransmission; and
periodicity that provides a periodicity of configured grant Type 2.

An actual UL grant is provided to the UE by the PDCCH (addressed to the CS-RNTI). After the UL grant is configured for configured grant Type 2, the UE may consider that the UL grant recurs in association with each symbol satisfying: [(SFN*memberOfSlotsPerFrame memberOfSymbolsPerSlot)+(slot number in the frame*memberOfSymbolsPerSlot)+symbol number in the slot]=[(SFN_{start time}*memberOfSlotsPerFrame*memberOfSymbolsPerSlot+slot_{start time}*memberOfSymbolsPerSlot+symbol_{start time})+N*periodicity] modulo (1024*numberOfSlotsPerFrame*numberOfSymbolsPerSlot), for all N>=0, where SFN_{start time}, slot_{start time}, and symbol_{start time} represent an SFN, a slot, and a symbol, respectively, of the first transmission opportunity of the PUSCH after the configured grant is (re-)initialized, and memberOfSlotsPerFrame and memberOfSymbolsPerSlot indicate the number of consecutive slots per frame and the number of consecutive OFDM symbols per slot, respectively (refer to Table 1 and Table 2).

ConfiguredGrantConfig, an RRC configuration used to configure a configured grant Type 1 or Type 2, may include configuredGrantTimer, a parameter indicating an initial value of a grant timer configured to a multiple of periodicity.

In some scenarios, a parameter harq-ProcID-Offset and/or a parameter harq-ProcID-Offset2 used to derive HARQ process IDs for configured UL grants may be further provided by the BS to the UE. harq-ProcID-Offset is an offset of a HARQ process for a configured grant for operation with shared spectrum channel access, and harq-ProcID-Offset2 is an offset of a HARQ process for a configured grant. In the present disclosure, cg-RetransmissionTimer is a duration after (re)transmission based on a configured grant in which the UE should not autonomously perform retransmission based on the HARQ process of the (re)transmission. cg-Retransmission Timer may be provided to the UE by the BS when retransmission on a configured UL grant is configured. For configured grants configured with neither harq-ProcID-Offset nor cg-Retransmission Timer, the HARQ process ID associated with the first symbol of UL transmission may be derived from the following equation: HARQ Process ID=[floor (CURRENT_symbol/periodicity)] modulo nrofHARQ-Processes. For configured UL grants with harq-ProcID-Offset2, the HARQ process ID associated with the first symbol of UL transmission may be derived from the following equation: HARQ Process ID=[floor (CURRENT_symbol/periodicity)] modulo nrofHARQ-Processes+harq-ProcID-Offset2, where CURRENT_symbol=(SFN*memberOfSlotsPerFrame*memberOfSymbolsPerSlot+slot number in the frame*memberOfSymbolsPerSlot+symbol number in the slot), and memberOfSlotsPerFrame and memberOfSymbolsPerSlot denote the number of consecutive slots per frame and the number of consecutive OFDM symbols per slot, respectively. For configured UL grants with cg-RetransmissionTimer, the UE may select a HARQ process ID from among HARQ process IDs available for the configured grant configuration.

On DL, the UE may be configured with semi-persistent scheduling (SPS) per serving cell and per BWP by RRC signaling from the BS. For DL SPS, DL assignment is provided to the UE by the PDCCH and stored or cleared based on L1 signaling indicating SPS activation or deactivation. When SPS is configured, the UE may be provided with the following parameters by the BS through RRC signaling (e.g., SPS configuration) used to configure a semi-persistent transmission:
cs-RNTI corresponding to a CS-RNTI for activation, deactivation, and retransmission;
nrofHARQ-Processes that provides the number of HARQ processes for SPS;
periodicity that provides a periodicity of configured DL assignment for SPS;
n1PUCCH-AN that provides a HARQ resource for a PUCCH for SPS (the network configures the HARQ resource as format 0 or format 1, and the actual PUCCH resource is configured by PUCCH-Config and referred to in n1PUCCH-AN by the ID thereof).

Multiple DL SPS configurations may be configured within the BWP of a serving cell. After DL assignment is configured for SPS, the UE may consider sequentially that N-th DL assignment occurs in a slot satisfying: (memberOfSlotsPerFrame*SFN+slot number in the frame)=[(memberOfSlotsPerFrame*SFN_{start time}+slot_{start time})+N*periodicity*memberOfSlotsPerFrame/10] modulo (1024*numberOfSlotsPerFrame), where SFN_{start time} and slot_{start time} represent an SFN and a slot, respectively, of first transmission of the PDSCH after configured DL assignment is (re-)initialized, and memberOfSlotsPerFrame and memberOfSymbolsPerSlot indicate the number of consecutive slots per frame and the number of consecutive OFDM symbols per slot, respectively (refer to Table 1 and Table 2).

In some scenarios, a parameter harq-ProcID-Offset used to derive HARQ process IDs for configured DL assignments may be further provided by the BS to the UE. harq-ProcID-Offset is an offset of a HARQ process for SPS. For configured DL assignments without harq-ProcID-Offset, a HARQ process ID associated with a slot in which DL transmission starts may be determined from the following equation: HARQ Process ID=[floor (CURRENT_slot*10/(memberOfSlotsPerFrame*periodicity))] modulo nrofHARQ-Processes, where CURRENT_slot=[(SFN*memberOfSlotsPerFrame)+slot number in the frame], and memberOfSlotsPerFrame denotes the number of consecutive slots per frame. For configured DL assignments with harq-ProcID-Offset, a HARQ process ID associated with a slot in which DL transmission starts may be determined from the following equation: HARQ Process ID=[floor (CURRENT_slot/periodicity)] modulo nrofHARQ-Processes+harq-ProcID-Offset, where CURRENT_slot=[(SFN*numberOfSlotsPerFrame)+slot number in the frame], and memberOfSlotsPerFrame denotes the number of consecutive slots per frame.

If the CRC of a corresponding DCI format is scrambled with the CS-RNTI provided by the RRC parameter cs-RNTI, and a new data indicator field for an enabled transport block is set to 0, the UE validates, for scheduling activation or scheduling release, a DL SPS assignment PDCCH or a configured UL grant Type 2 PDCCH. Validation of the DCI format is achieved if all fields for the DCI format are set according to Table 5 and Table 6. Table 5 shows an example of special fields for DL SPS and UL grant Type 2 scheduling activation PDCCH validation, and Table 6 shows an example of special fields for DL SPS and UL grant Type 2 scheduling release PDCCH validation.

TABLE 5

| | DCI format 0_0/0_1 | DCI format 1_0 | DCI format 1_1 |
|---|---|---|---|
| HARQ process | set to all ‘0's | set to all ‘0's | set to all ‘0's |
| number | | | |
| Redundancy | set to ‘00’ | set to ‘00’ | For the enabled transport |
| version | | | block: set to ‘00’ |

TABLE 6

| | DCI format 0_0 | DCI format 1_0 |
|---|---|---|
| HARQ process | set to all ‘0's | set to all ‘0's |
| number | | |
| Redundancy | set to ‘00’ | set to ‘00’ |
| version | | |
| Modulation and | set to all ‘1's | set to all ‘1's |
| coding scheme | | |
| Resource block | set to all ‘1's | set to all ‘1's |
| assignment | | |

Actual DL assignment and UL grant for DL SPS or UL grant Type 2, and a corresponding MCS are provided by resource assignment fields (e.g., a TDRA field providing a TDRA value m, an FDRA field providing frequency resource block assignment, and/or an MCS field) in the DCI format carried by a corresponding DL SPS or UL grant Type 2 scheduling activation PDCCH. If validation is achieved, the UE considers information in the DCI format as valid activation or valid release of DL SPS or configured UL grant Type 2.

In the present disclosure, a PDSCH based on DL SPS may be referred to as an SPS PDSCH, and a PUSCH based on a UL configured grant (CG) may be referred to as a CG PUSCH. A PDSCH dynamically scheduled by DCI carried on a PDCCH may be referred to as a dynamic grant (DG) PDSCH, and a PUSCH dynamically scheduled by DCI carried by on a PDCCH may be referred to as a DG PUSCH.

FIG. 7 illustrates a HARQ-ACK transmission/reception procedure.

Referring to FIG. 7, the UE may detect a PDCCH in a slot n. Next, the UE may receive a PDSCH in a slot n+K0 according to scheduling information received through the PDCCH in the slot n and then transmit UCI through a PUCCH in a slot n+K1. In this case, the UCI includes a HARQ-ACK response for the PDSCH.

The DCI (e.g., DCI format 1_0 or DCI format 1_1) carried by the PDCCH for scheduling the PDSCH may include the following information.
Frequency domain resource assignment (FDRA): FDRA indicates an RB set allocated to the PDSCH.
Time domain resource assignment (TDRA): TDRA indicates a DL assignment-to-PDSCH slot offset K0, the start position (e.g., symbol index S) and length (e.g., the number of symbols, L) of the PDSCH in a slot, and the PDSCH mapping type. PDSCH mapping Type A or PDSCH mapping Type B may be indicated by TDRA. For PDSCH mapping Type A, the DMRS is located in the third symbol (symbol #2) or fourth symbol (symbol #3) in a slot. For PDSCH mapping Type B, the DMRS is allocated in the first symbol allocated for the PDSCH.
PDSCH-to-HARQ_feedback timing indicator: This indicator indicates K1.

If the PDSCH is configured to transmit a maximum of one TB, a HARQ-ACK response may consist of one bit. If the PDSCH is configured to transmit a maximum of 2 TBs, the HARQ-ACK response may consist of 2 bits when spatial bundling is not configured and one bit when spatial bundling is configured. When a HARQ-ACK transmission timing for a plurality of PDSCHs is designated as slot n+K1, UCI transmitted in slot n+K1 includes a HARQ-ACK response for the plural PDSCHs.

In the present disclosure, a HARQ-ACK payload consisting of HARQ-ACK bit(s) for one or plural PDSCHs may be referred to as a HARQ-ACK codebook. The HARQ-ACK codebook may be categorized as i) a semi-static HARQ-ACK codebook, ii) a dynamic HARQ-ACK codebook and iii) HARQ process based HARQ-ACK codebook, according to a HARQ-ACK payload determination scheme.

In the case of the semi-static HARQ-ACK codebook, parameters related to a HARQ-ACK payload size that the UE is to report are semi-statically determined by a (UE-specific) higher layer (e.g., RRC) signal. The HARQ-ACK payload size of the semi-static HARQ-ACK codebook, e.g., the (maximum) HARQ-ACK payload (size) transmitted through one PUCCH in one slot, may be determined based on the number of HARQ-ACK bits corresponding to a combination (hereinafter, bundling window) of all DL carriers (i.e., DL serving cells) configured for the UE and all DL scheduling slots (or PDSCH transmission slots or PDCCH monitoring slots) for which the HARQ-ACK transmission timing may be indicated. That is, in a semi-static HARQ-ACK codebook scheme, the size of the HARQ-ACK codebook is fixed (to a maximum value) regardless of the number of actually scheduled DL data. For example, DL grant DCI (PDCCH) includes PDSCH-to-HARQ-ACK timing information, and the PDSCH-to-HARQ-ACK timing information may have one (e.g., k) of a plurality of values. For example, when the PDSCH is received in slot #m and the PDSCH-to-HARQ-ACK timing information in the DL grant DCI (PDCCH) for scheduling the PDSCH indicates k, the HARQ-ACK information for the PDSCH may be transmitted in slot #(m+k). As an example, k∈{1, 2, 3, 4, 5, 6, 7, 8}. When the HARQ-ACK information is transmitted in slot #n, the HARQ-ACK information may include possible maximum HARQ-ACK based on the bundling window. That is, HARQ-ACK information of slot #n may include HARQ-ACK corresponding to slot #(n−k). For example, when k∈{1, 2, 3, 4, 5, 6, 7, 8}, the HARQ-ACK information of slot #n may include HARQ-ACK corresponding to slot #(n−8) to slot #(n−1) regardless of actual DL data reception (i.e., HARQ-ACK of a maximum number). Here, the HARQ-ACK information may be replaced with a HARQ-ACK codebook or a HARQ-ACK payload. A slot may be understood/replaced as/with a candidate occasion for DL data reception. As described in the example, the bundling window may be determined based on the PDSCH-to-HARQ-ACK timing based on a HARQ-ACK slot, and a PDSCH-to-HARQ-ACK timing set may have predefined values (e.g., {1, 2, 3, 4, 5, 6, 7, 8}) or may be configured by higher layer (RRC) signaling. The semi-static HARQ-ACK codebook is referred to as a Type-1 HARQ-ACK codebook. For the Type-1 HARQ-ACK codebook, the number of bits to be transmitted in a HARQ-ACK report is fixed and may be potentially large. If many cells are configured but only few cells are scheduled, the Type-1 HARQ-ACK codebook may be inefficient.

In the case of the dynamic HARQ-ACK codebook, the HARQ-ACK payload size that the UE is to report may be dynamically changed by the DCI etc. The dynamic HARQ-ACK codebook is referred to as a Type-2 HARQ-ACK codebook. The Type-2 HARQ-ACK codebook may be considered as optimized HARQ-ACK feedback because the UE sends feedback only for scheduled serving cells. However, in poor channel conditions, the UE may erroneously determine the number of scheduled serving cells. To solve this problem, a downlink assignment index (DAI) may be included as a part of DCI. For example, in the dynamic HARQ-ACK codebook scheme, DL scheduling DCI may include a counter-DAI (i.e., c-DAI) and/or a total-DAI (i.e., t-DAI). Here, the DAI indicates a downlink assignment index and is used for the BS to inform the UE of transmitted or scheduled PDSCH(s) for which HARQ-ACK(s) are to be included in one HARQ-ACK transmission. Particularly, the c-DAI is an index indicating order between PDCCHs carrying DL scheduling DCI (hereinafter, DL scheduling PDCCHs), and t-DAI is an index indicating the total number of DL scheduling PDCCHs up to a current slot in which a PDCCH with the t-DAI is present.

In the case of a HARQ-ACK codebook based on HARQ processes, the HARQ-ACK payload is determined based on all HARQ processes of all configured (or activated) serving cells in a PUCCH group. For example, the size of the HARQ-ACK payload to be reported by the UE using the HARQ-ACK codebook based on HARQ processes may be determined based on the number of all configured or activated serving cells in the PUCCH group configured for the UE and the number of HARQ processes for the serving cells. The HARQ-ACK codebook based on HARQ processes is also referred to as a Type-3 HARQ-ACK codebook. The type-3 HARQ-ACK codebook may be applied to one-shot feedback.

Extended reality (XR) is an ultra-immersive technology and service that provides an environment in which the users are capable of communicating and living without restrictions on time and space in a virtual space similar to reality by utilizing virtual reality (VR), augmented reality (AR), mixed reality (MR), holography, etc. XR is one of major services to be introduced in an NR wireless communication system. XR is typically characterized by specific traffic with one or more DL video streams which are closely synchronized with frequent UL pose/control updates. XR has a high data rate and a strict packet delay budget (PDB). The PDB defines an upper bound for the time that a packet may be delayed between a UE and a user plane function (UPF) of a core network. In other words, the PDB may be a value regarding the upper bound of the time during which a generated packet needs to be transmitted.

In NR, one or more SPS PDSCHs or CG PUSCHs may be configured for the UE for periodic transmission and reception or for low latency and PDCCH overhead. The corresponding configuration/indicated resource may recur in the time domain with a periodicity according to each SPS/CG configuration. For example, the initially configured/indicated resource allocation may be repeated with a periodicity configured according to the SPS/CG configuration, and the UE may perform DL reception/UL transmission in the corresponding resource without a separate PDCCH reception process. The types of data to be generated in the XR are diverse. From among these data, it is considered that transmissions of information regarding a UE sensor and location thereof and video data, which are generally reported with a specific periodicity, are transmitted and received in SPS/CG resources. These data may have irregular traffic arrival times and jitter due to reasons such as video encoding time, sensor measurement time, higher layer operation, or routing changes in a network through which the data is transmitted.

In the NR, priorities at a PHY layer are introduced for a plurality of services, which allows the UE to perform UL transmission or DL reception by using only one of overlapping radio resources or to divide the overlapping UL transmission into a plurality of groups to perform UL multiplexing. The XR has the characteristic of displaying an image on a screen accurately over time, and thus previous data may become useless once a time by which XR data is required to be provided passes.

To support mobility and allow the UE to identify the best serving cell, intra-cell or inter-cell measurements are performed by the UE. If the UE is incapable of measuring a target carrier frequency while simultaneously transmitting/receiving on the serving cell, measurement gaps are required to perform the measurement. Measurement gaps may be required for intra-frequency, inter-frequency, and inter-RAT measurements. For example, measurement gap repetition periodicities such as 20, 40, 80, and 60 ms, and measurement gap durations such as 1.5, 3, 3.5, 4, 5.5, and 6 ms may be used for measurement gaps. The UE may switch to a target cell during a measurement gap (MG) to perform signal quality measurement and return to a current cell. In some scenarios, an RF re-tuning time is 0.5 ms for carrier frequency measurements in the FR1 range and 0.25 ms for the FR2 range. During MGs, measurements may be performed on SSBs of neighboring cells. The network (e.g., BS) may provide measurement timings for neighboring cells using an SS/PBCH block measurement timing configuration (SMTC). The MG and SMTC periods may be configured to allow the UE to identify and measure the SSBs within the SMTC. The network may provide the UE with an MG pattern through RRC signaling (e.g., the IE MeasGapConfig IE within the RRC configuration MeasConfig). The RRC configuration IE MeasGapConfig is used to specify an MG configuration and control the setup/release of MGs (refer to 3GPP TS 38.331). MGs may be periodic, and the UE may be configured with multiple MGs.

The MG configuration is required to support mobility and allow the UE to identify the best serving cell. However, the MG configuration causes suspension of signal transmission/reception for the UE to perform measurements for intra/inter-frequency handovers and/or beam management. For example, according to 3GPP TS 38.321 Release 17, during an activated MG, the UE may perform the following operations on serving cell(s) within the frequency range of the MG configured by the RRC configuration MeasGapConfig:
not transmitting HARQ feedback, SR, and CSI;
not reporting an SRS;
not performing transmission on a UL-SCH, except for first scheduled transmission of the random access procedure, Msg3 or MsgA payload;
If ra-ResponseWindow, which is a time window for monitoring random access response(s) on an SpCell, ra-ContentionResolutionTimer, which is a contention resolution timer for the SpCell, or msgB-ResponseWindow, which is a time window for monitoring random access response(s) for the 2-step random access type on the SpCell, is running, the UE monitors a PDCCH, and otherwise (else), the UE does not monitor the PDCCH and does not perform reception on a DL-SCH. Here, the length of ra-Response Window, the value of ra-ContentionResolution Timer, and the length of msgB-ResponseWindow are provided to the UE by the network through RRC signaling.

The MG configuration is required for XR applications supporting mobility or delay-sensitive services like URLLC. However, according to the current standards, since measurements based on the MG have a higher priority than PDSCH receptions or PUSCH transmissions carrying data for these services, the services are interrupted during the MG period. For services with strict latency requirements, such as XR or URLLC services, it is required that corresponding data or scheduling information for the data be provided in a timely manner. Therefore, for latency-sensitive XR or URLLC services, the MG, which is a time period during which scheduling information is not available, may cause significant issues.

In some scenarios (e.g., NR systems), the UE may be provided with an MG configuration for intra-cell or inter-cell measurements by the BS. As described above, according to the current NR standards, when the UE is explicitly provided with the MG configuration, the UE is not expected to perform PUCCH/PUSCH/SRS transmission or PDCCH/PDSCH/CSI-RS reception during the MG period, especially in the case of measurements based on SSB reception. If the BS configures an MG for the UE according to SSB reception occasion(s) of the UE, the UE typically has an MG period every 20 ms, and each MG period may have a duration of 1 to 5 ms. If the UE has a 5 ms MG period every 20 ms periodicity, the UE may not perform PUCCH/PUSCH/SRS transmission or PDCCH/PDSCH/CSI-RS reception for 5 ms every 20 ms, which may impact the availability of the UE. For example, when the UE is configured with SPS or CG radio resources from the BS to receive or transmit periodic sensor information, if an MG period overlaps in time with an SPS-based reception occasion/CG-based transmission occasion, the UE may not perform SPS-based reception/CG-based transmission.

As a solution to these issues, a mechanism for preventing an overlap between XR/URLLC packet scheduling and MG periods may be considered. However, considering that MG periods based on the RRC configuration are semi-static, while the generation and scheduling of XR/URLLC data are dynamic, preventing the overlap between the MG periods and the XR/URLLC data generation and scheduling is practically impossible or requires a significantly complex mechanism. Therefore, defining a mechanism for preventing an overlap between MG periods and data transmission/reception scheduling in time may not be desirable or practically feasible.

The following describes some implementations of the present disclosure to address the above-described issues. In some implementations of the present disclosure, operations between the UE and BS that allows transmission/reception on an MG based on predetermined criteria may be considered.

For the convenience of explanation, examples of some implementations of the present disclosure are described based on the NR system. However, unless otherwise stated, the implementations of the present disclosure are not limited to the specific transmission/reception forms of NR. Additionally, for the convenience of explanation, some implementations of the present disclosure are described based on the characteristics and structure of XR services. However, unless otherwise stated, the implementations of the present disclosure are not limited to the support of XR services.

In the following, for example, when the UE is provided with MG configuration(s) for intra-cell or inter-cell measurements from the BS, and the UE needs to periodically perform measurements on neighboring cells or the current serving cell during the MG for purposes such as radio resource management (RRM), if the UE is indicated or configured by the BS to receive one or more pieces of scheduling for delay-sensitive services such as XR/URLLC on the MG, some implementations of the present disclosure for handling the scheduling are described.

The implementations of the present disclosure described below may include methods of allocating, by the BS, PDSCH/PUSCH radio resources to the UE and methods of performing, by the UE, DL reception and UL transmission on the allocated radio resources. Further, the implementations may include methods of transmitting HARQ-ACK PUCCH responses for PDSCH reception results and methods of receiving DCI retransmitted by the BS over a PDCCH after PUSCH transmission. Additionally, the implementations of the present disclosure described below may include processes for the UE to transmit signals and channels to notify the capabilities and/or service requirements thereof and processes for the BS to receive the signals and channels.

In some implementations of the present disclosure, a transmission occasion may refer to radio resources (e.g., SPS PDSCH or CG PUSCH) that occur based on an SPS/CG configuration. The transmitter, which is an entity performing the transmission (e.g., BS for DL, UE for UL), may attempt to transmit physical channels/signals at the transmission occasion, and the receiver (e.g., UE for DL, BS for UL) may attempt to receive by expecting that the transmitter will transmit at each transmission occasion. In the present disclosure, the term “transmission occasion” is used interchangeably with the term “transmission opportunity.” Additionally, in the present disclosure, the transmission occasion may be referred to as the reception occasion from the perspective of the receiver. Alternatively, the term “occasion” may be used in place of both “transmission occasion” and “reception occasion.”

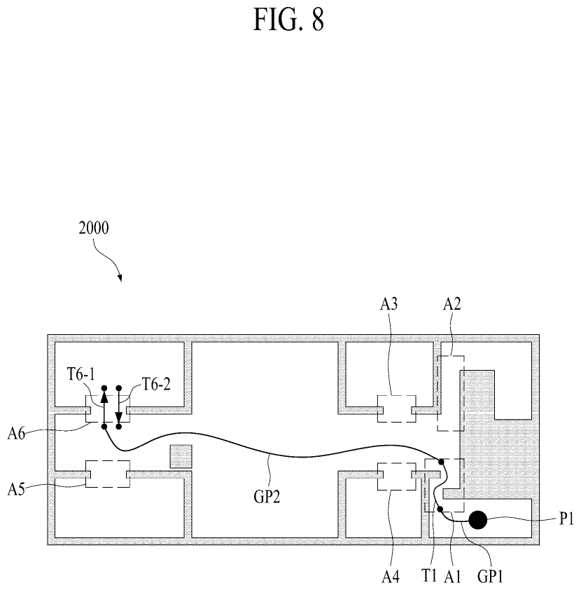

FIG. 8 illustrates a flow of UE operations to which some implementations of the present disclosure are applicable.

The UE may receive MG periods for RRM from the BS via RRC signaling (e.g., RRC configuration MeasConfig and/or RRC configuration MeasGapConfig) (S801). For example, one or more MG configurations may be provided to the UE by the BS. In some implementations of the present disclosure, information regarding the configured MG periods (e.g., MG configuration) may include information about the priority of each MG period, or the indices of PDCCH, CSI-RS, SR, and/or SPS/CG configurations related to the MG periods. For example, in some implementations of the present disclosure, each MG configuration may include priority information regarding the corresponding MG(s), or the indices of the related PDCCH, CSI-RS, SR, and/or SPS/CG configuration(s).

When a PDSCH reception occasion based on explicit scheduling via L1 signaling (e.g., PDCCH) or an SPS configuration or a PUSCH transmission occasion based on explicit scheduling via L1 signaling (e.g., PDCCH) or a CG configuration does not overlap (in time) with an MG according to the MG configuration (S803, No), the UE may perform operation A1 (S804). Operation A1 may include: performing measurements configured by the RRC configuration MeasConfig related to the MG configuration within the MG; and attempting PDSCH reception at the PDSCH reception occasion or performing PUSCH transmission at the PUSCH transmission occasion. When the PDSCH reception occasion based on the explicit scheduling via L1 signaling (e.g., PDCCH) or the SPS configuration or the PUSCH transmission occasion based on the explicit scheduling via L1 signaling (e.g., PDCCH) or the CG configuration overlaps (in time) with the MG according to the MG configuration (S803, Yes), if specific condition(s) are not satisfied (S805, No), the UE may perform operation A2 (S806). If the specific condition(s) are satisfied (S805, Yes), the UE may attempt PDSCH reception at the PDSCH reception occasion or attempt PUSCH transmission at the PUSCH transmission occasion within the MG (S807). Operation A2 may include the following:
i) The UE performs the measurements configured by the RRC configuration MeasConfig related to the MG configuration within the MG; and
ii) On serving cell(s) within the frequency range of the MG:
The UE does not transmit HARQ feedback, SR, and CSI;
The UE does not report an SRS;
The UE does not perform transmission on a UL-SCH, except for first scheduled transmission of the random access procedure, Msg3 or MsgA payload;
If ra-ResponseWindow, which is a time window for monitoring random access response(s) on an SpCell, ra-ContentionResolutionTimer, which is a contention resolution timer for the SpCell, or msgB-ResponseWindow, which is a time window for monitoring random access response(s) for the 2-step random access type on the SpCell, is running, the UE monitors a PDCCH, and otherwise (else), the UE does not monitor the PDCCH and does not perform reception on a DL-SCH.

In some implementations, if the specific condition(s) are satisfied (S805, Yes), the UE may perform the measurements related to the MG within the MG. Alternatively, in some implementations, if the specific condition(s) are satisfied (S805, Yes), the UE may not perform the measurements related to the MG within the MG.

The specific condition(s) may include condition(s) according to any one or more of Implementations 1 to 5 described below.

To clarify, in some implementations of the present disclosure, the UE may receive a scheduling message or SPS/CG configuration for PDSCH reception or PUSCH transmission in an MG period from the BS. If the UE is instructed to perform PDSCH reception or PUSCH transmission in the MG period through an explicit scheduling message via L1 signaling (e.g., PDCCH), the UE may perform the indicated PDSCH reception or PUSCH transmission without performing neighboring cell measurements in the corresponding MG period. If an SPS reception occasion (i.e., SPS PDSCH reception occasion) and/or a CG transmission occasion (i.e., CG PUSCH transmission occasion) occurs in the MG period, the UE may perform SPS reception or CG transmission based on the characteristics of the corresponding MG period. For example, when information regarding the priority of the MG period is included in an MG configuration, if the information regarding the priority is less than or equal to a predetermined threshold, the UE may perform the indicated or configured PDSCH reception or PUSCH transmission without performing neighboring cell measurements in the corresponding MG period. In another example, when information regarding a related SPS configuration and/or CG configuration is included in the MG configuration, if PDSCH reception/PUSCH transmission based on an SPS/CG configuration with the same index as the related SPS/CG configuration overlaps with the MG based on the MG configuration, the UE may perform the PDSCH reception or PUSCH transmission without performing neighboring cell measurements in the corresponding MG period.

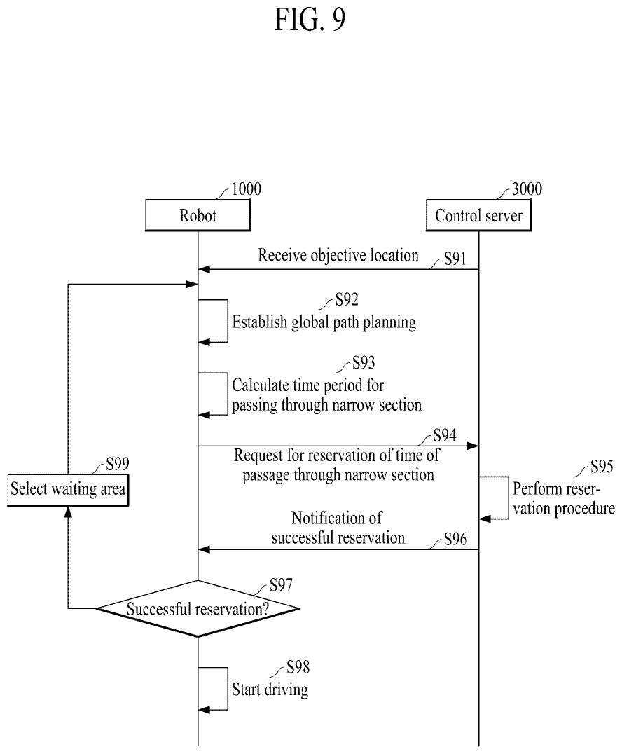

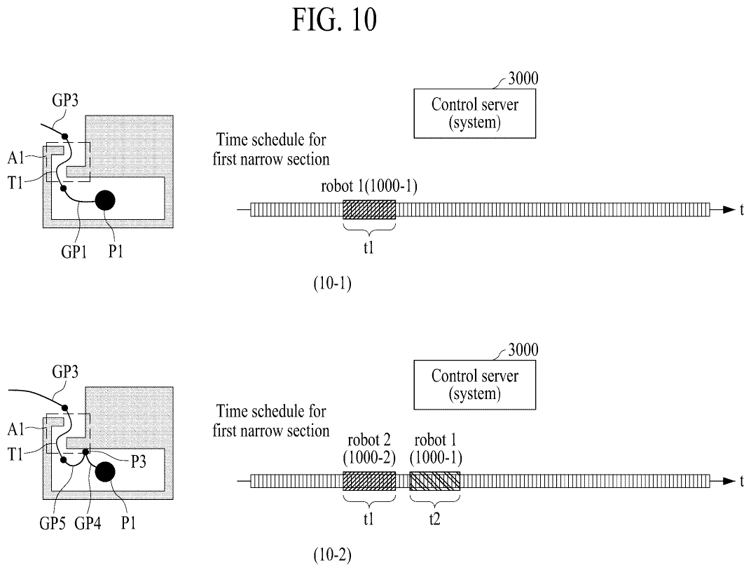

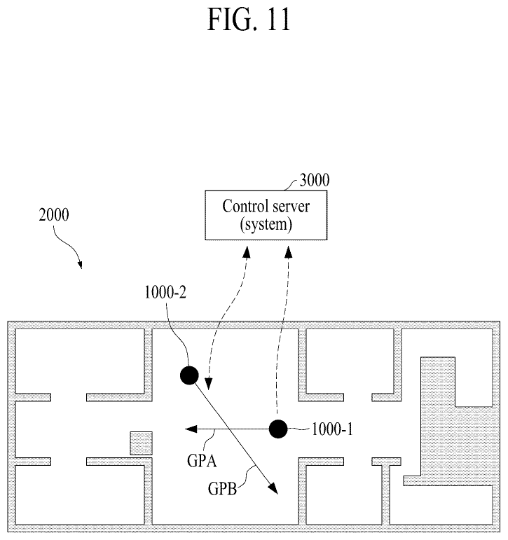

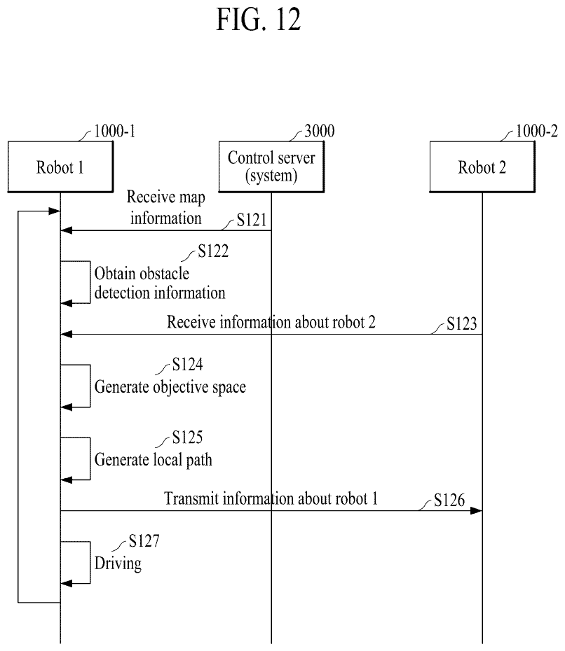

FIG. 9 illustrates a flow of BS operations to which some implementations of the present disclosure are applicable.

The BS may configure MG periods for RRM to the UE through RRC signaling (e.g., RRC configuration MeasConfig and/or RRC configuration MeasGapConfig) (S901). For example, one or more MG configurations may be provided to the UE by the BS. In some implementations of the present disclosure, information regarding the configured MG periods (e.g., MG configuration) may include information about the priority of each MG period, or the indices of PDCCH, CSI-RS, SR, and/or SPS/CG configurations related to the MG periods. For example, in some implementations of the present disclosure, each MG configuration may include priority information regarding the corresponding MG(s), or the indices of the related PDCCH, CSI-RS, SR, and/or SPS/CG configuration(s).

When a PDSCH transmission occasion based on explicit scheduling via L1 signaling (e.g., PDCCH) or an SPS configuration or a PUSCH reception occasion based on explicit scheduling via L1 signaling (e.g., PDCCH) or a CG configuration does not overlap (in time) with an MG according to the MG configuration (S903, No), the BS may assume that the UE will perform operation A1 as illustrated in FIG. 8 and may perform operation B1 (S904). According to operation B1, the BS may receive a measurement report related to the MG from the UE by assuming that the UE will perform measurements configured by the RRC configuration MeasConfig related to the MG configuration within the MG. Assuming that the UE will receive PDSCH at the PDSCH transmission occasion or transmit PUSCH at the PUSCH reception occasion, the BS may perform PDSCH transmission at the PDSCH transmission occasion and attempt PUSCH reception at the PUSCH reception occasion by assuming that the UE will receive the PDSCH at the PDSCH transmission occasion or transmit the PUSCH at the PUSCH reception occasion. When the PDSCH transmission occasion based on the explicit scheduling via L1 signaling (e.g., PDCCH) or the SPS configuration or the PUSCH reception occasion based on the explicit scheduling via L1 signaling (e.g., PDCCH) or the CG configuration does not overlap (in time) with the MG according to the MG configuration (S903, Yes), if specific condition(s) are not satisfied (S905, No), the BS may assume that the UE will perform operation A2 as illustrated in FIG. 8 and perform operation B2 (S906). If the specific condition(s) are satisfied (S905, Yes), the BS may assume that the UE will receive the PDSCH at the PDSCH transmission occasion or transmit the PUSCH at the PUSCH reception occasion within the MG and perform PDSCH transmission at the PDSCH transmission occasion or attempt PUSCH reception at the PUSCH reception occasion (S907).

Operation B2 may include the following:
i) The BS receives the measurement report related to the MG from the UE by assuming that the UE will perform the measurements configured by the RRC configuration MeasConfig related to the MG configuration within the MG; and/or
ii) On serving cell(s) within the frequency range of the MG:
The BS does not expect or attempt to receive HARQ feedback, SR, and CSI from the UE;
The BS does not expect or attempt to receive an SRS report from the UE;
The BS does not expect or attempt to perform reception from the UE on a UL-SCH, except for first scheduled transmission of the random access procedure, Msg3 or MsgA payload;
If ra-ResponseWindow, which is a time window for monitoring random access response(s) on an SpCell, ra-ContentionResolutionTimer, which is a contention resolution timer for the SpCell, or msgB-ResponseWindow, which is a time window for monitoring random access response(s) for the 2-step random access type on the SpCell, is running, the BS transmits a PDCCH to the UE, and otherwise (else), the BS does not transmit the PDCCH and does not perform to the UE on a DL-SCH.

In some implementations, if the specific condition(s) are satisfied (S905, Yes), the BS may expect/assume that the UE will perform the measurements related to the MG within the MG. Alternatively, in some implementations, if the specific condition(s) are satisfied (S905, Yes), the BS may expect/assume that the UE will not perform the measurements related to the MG within the MG.

The specific condition(s) may include condition(s) according to any one or more of Implementations 1 to 5 described below.

To clarify, in some implementations of the present disclosure, the BS may transmit a scheduling message or SPS/CG configuration for PDSCH reception or PUSCH transmission in an MG period to the UE. If the BS instructs the UE to perform PDSCH reception or PUSCH transmission in the MG period through an explicit scheduling message via L1 signaling (e.g., PDCCH), the BS may expect or assume the UE will perform the indicated PDSCH reception or PUSCH transmission without performing neighboring cell measurements in the corresponding MG period, and may perform the PDSCH transmission or attempt the PUSCH reception. If an SPS transmission occasion (i.e., SPS PDSCH transmission occasion) and/or a CG reception occasion (i.e., CG PUSCH reception occasion) occurs for the UE in the MG period, the BS may expect or assume that the UE will perform SPS reception or CG transmission based on the characteristics of the corresponding MG period and operate accordingly. For example, when information regarding the priority of the MG period is included in an MG configuration, if the information regarding the priority is less than or equal to a predetermined threshold, the BS may expect/assume that the UE will perform the indicated or configured PDSCH reception or PUSCH transmission without performing neighboring cell measurements in the corresponding MG period and operate accordingly. In another example, when information regarding a related SPS configuration and/or CG configuration is included in the MG configuration, if PDSCH transmission/PUSCH reception based on an SPS/CG configuration with the same index as the related SPS/CG configuration overlaps with the MG based on the MG configuration, the BS may expect/assume that the UE will perform the corresponding PDSCH reception or PUSCH transmission without performing neighboring cell measurements in the corresponding MG period and operate accordingly.

In FIGS. 8 and 9, a UE operation flow and a BS operation flow are described with cases where a PDSCH/PUSCH occasion overlaps with an MG. However, the UE and BS may also operate in the same manner as described in FIGS. 8 and 9 for SRS occasions, CSI-RS occasions, and PUCCH occasions.

Some of the methods according to Implementations 1 to 5 of the present disclosure described below may be selected and applied individually. Alternatively, each method may be applied independently without any combination, or one or more methods may be combined and operate in an integrated way.

Some implementations of the present disclosure may be applied only when the UE receives relevant configuration information from the BS (or core network). In this case, the configuration information may be provided to the UE via higher layer signals (e.g., SIB or RRC signaling), or the configuration information may be activated/deactivated through separate signaling (e.g., DCI or MAC control elements). Additionally, in some implementations of the present disclosure, the UE may be configured to report information about the supportability of the method(s) described below (e.g., capability), and the BS (or core network) may be configured to receive the information.

When an MG based on an MC configuration overlaps with a physical channel/signal, the following implementations may be considered for handling the MG and/or the physical channel/signal.

### <Implementation 1: Ignore/Disable MG Via Explicit Scheduling DCI>

When the UE receives explicit scheduling DCI with the following characteristics, if resources scheduled by the DCI overlap with an MG, the UE may prioritize transmission or reception of the radio resources indicated by the scheduling DCI (i.e., the transmission or reception on the radio resources) without performing measurements on the MG. The characteristics may include at least one of the following.
DCI indicating higher priority (HP) PUCCH/PUSCH/SRS transmission or HP PDCCH/PDSCH/CSI-RS reception. For example, Implementation 1 may be used for reception/transmission scheduled by DCI that includes a priority index greater than a certain threshold (e.g., 0). The threshold may be indicated via L1 signaling or higher layer signaling from the BS when the UE has three or more available priorities. If the UE has two available priorities, the threshold may be 0.
DCI indicating SPS/CG activation
DCI indicating DL reception
DCI indicating UL transmission

In some implementations, Implementation 1 may be limited to DL reception scheduling or UL transmission scheduling only. If Implementation 1 is limited to DL reception scheduling, the UE may not apply Implementation 1 when transmitting a HARQ-ACK response for a PDSCH, which is received during a DL reception process, on a PUCCH/PUSCH. If Implementation 1 is limited to DL transmission scheduling, the BS may not apply Implementation 1 when receiving a HARQ-ACK response for a PDSCH, which is transmitted during a DL transmission process, on a PUCCH/PUSCH.

In some implementations, the application of operations in Implementation 1 may vary for each MG configuration. For example, when the explicit scheduling DCI with the characteristics overlaps with a specific MG, the UE may perform the transmission or reception of the radio resources indicated by the scheduling DCI (i.e., the transmission or reception on the radio resources) without performing measurements on the MG. The specific MG may be determined based on the presence or absence of certain parameters in the MG configuration or by the values of certain parameters. For example, the specific MG may be determined based on that the size of an RRC parameter mgl or mgl-r16, which indicates the length of the MG period (i.e., MG length), is more than or equal to a certain threshold, or based on whether the RRC parameter mgl-r16 exists or does not exist (in the MG configuration).

### <Implementation 2: Ignore/Disable MG for Specific SPS/CG>

When the UE receives an SPS/CG configuration with the following characteristics, if the reception/transmission opportunities of radio resources of the corresponding SPS/CG configuration (i.e., the transmission/reception opportunities on the radio resources) overlap in time with an MG, the UE may prioritize transmission or reception of radio resources indicated by scheduling DCI (i.e., the transmission or reception on the radio resources) without performing measurements on the MG. The characteristics may include at least one of the following.
An SPS/CG configuration configured with HP. For example, Implementation 2 may be applied to reception/transmission opportunities obtained from an SPS/CG configuration with a priority index greater than a certain threshold (e.g., 0). The threshold may be indicated via L1 signaling or higher layer signaling from the BS when the UE has three or more available priorities. If the UE has two available priorities, the threshold may be 0.
An SPS/CG configuration including a specific RRC parameter. In some implementations, the specific RRC parameter may be used to configure whether Implementation 2 is applied.
An SPS configuration indicating DL reception
A CG configuration indicating UL transmission

In some implementations, applying Implementation 2 may be limited to DL reception SPS only, or UL transmission CG only. If Implementation 2 is limited to DL reception SPS, the UE may not apply Implementation 2 when transmitting a HARQ-ACK response for a PDSCH, which is received at a corresponding SPS reception opportunity, on a PUCCH/PUSCH. If Implementation 2 is limited to DL transmission SPS, the BS may not apply Implementation 2 when receiving a HARQ-ACK response for a PDSCH, which is transmitted at a corresponding SPS transmission occasion, on a PUCCH/PUSCH.

In some implementations, the application of operations in Implementation 2 may vary for each MG configuration. For example, if the PDSCH reception opportunity based on the SPS configuration with the characteristics and/or the PUSCH transmission opportunity based on the CG configuration with the characteristics overlaps with a specific MG, the UE may perform the transmission or reception of the radio resources (i.e., the transmission or reception on the radio resources) based on the corresponding configuration without performing measurements on the MG. If the PDSCH transmission opportunity based on the SPS configuration with the characteristics and/or the PUSCH reception opportunity based on the CG configuration with the characteristics overlaps with the specific MG, the BS may operate by expecting/assuming that the UE will perform the transmission or reception of the radio resources (i.e., the transmission or reception on the radio resources) based on the corresponding configuration without performing measurements on the MG. The specific MG may be determined based on the presence or absence of certain parameters in the MG configuration or by the values of certain parameters. For example, the specific MG may be determined based on that the size of an RRC parameter mgl or mgl-r16, which indicates the length of the MG period (i.e., MG length), is more than or equal to a certain threshold, or based on whether the RRC parameter mgl-r16 exists or does not exist (in the MG configuration).

### <Implementation 3: Ignore/Disable MG for Specific Search Space/CORESET>

When the UE receives an SS and/or CORESET with the following characteristics (i.e., if the UE receives an SS configuration and/or CORESET configuration with the following characteristics), if a PDCCH monitoring opportunity (i.e., PDCCH monitoring occasion) indicated by the SS/CORESET configuration overlaps in time with an MG, the UE may prioritize PDCCH monitoring for PDCCH reception/detection without performing measurements on the MG. The characteristics may include at least one of the following.
An SS/CORESET configuration including a specific RRC parameter. In some implementations, the specific RRC parameter may be used to configure whether Implementation 3 is used.
An SS configuration for receiving a specific DCI format. In some implementations, the specific DCI format may include, for example, group common DCIs such as DCI format 2_x (e.g., DCI format 2_0, 2_1, 2_2, 2_4, 2_5, 2_6, 2_7, etc.) or DCI formats 0_2 and 1_2 specified in 3GPP TS 38.212. The BS may transmit group common DCI to UEs communicating in the frequency range associated with the MG and instruct the UEs to prioritize PDCCH monitoring over the MG. DCI formats 0_2 and 1_2 are compact DCI with relatively small payload sizes compared to other scheduling DCI formats, which may enhance transmission reliability. Thus, the BS may use DCI formats 0_2 and 1_2 to prioritize scheduling for specific services over the MG.

In some implementations, the application of operations in Implementation 3 may vary for each MG configuration. For example, if the PDCCH monitoring occasion based on the SS configuration and/or CORESET configuration with the characteristics overlaps with a specific MG, the UE may perform PDCCH monitoring on the PDCCH monitoring occasion without performing measurements on the MG. If the PDCCH monitoring occasion based on the SS configuration and/or CORESET configuration with the characteristics overlaps with the specific MG, the BS may operate by expecting/assuming that the UE will perform PDCCH monitoring on the PDCCH monitoring occasion without performing measurements on the MG. The specific MG may be determined based on the presence or absence of certain parameters in the MG configuration or by the values of certain parameters. For example, the specific MG may be determined based on that the size of an RRC parameter mgl or mgl-r16, which indicates the length of the MG period (i.e., MG length), is more than or equal to a certain threshold, or based on whether the RRC parameter mgl-r16 exists or does not exist (in the MG configuration).

Even if it is not a time window for receiving a random access response or contention resolution message during the random access procedure, the UE may monitor a PDCCH monitoring occasion based on an SS (set) and/or CORESET, which satisfies specific conditions according to Implementation 3, within the MG.

<Implementation 4: Enhanced Measurement Configuration with Prioritization>

The UE may be configured with one or more MGs from the BS. Each MG configuration may have a priority for a first type of scheduling, which is explicit scheduling for PUCCH/PUSCH/SRS transmission or PDSCH/CSI-RS reception at the BS (e.g., dynamic scheduling through L1 messages) and a priority for a second type of scheduling, which is implicit scheduling (e.g., semi-static scheduling through L2 messages (e.g., RRC configuration) or a PDCCH monitoring opportunity configuration via an SS/CORESET configuration). For example, each MG configuration may include priority information regarding the first type of scheduling and priority information regarding the second type of scheduling. An MG configuration with a lower priority than each type of scheduling allows the corresponding type of scheduling on the MG period indicated by the MG configuration. If scheduling with a higher priority than the MG configuration overlaps in time with the corresponding MG period, the UE may perform the transmission or reception without performing measurements in the MG period. That is, when two levels of priorities: lower and higher priorities are used, the MG configuration may not include priority indices or include a lower priority index or a higher priority index. An MG configuration with a higher priority index for a certain type of scheduling may not allow any transmission/reception for the corresponding type of scheduling. An MG configuration with a lower priority index may be defined to only allow transmission/reception with a priority index/indicator higher or equal to a higher priority index. For example, if DCI or an SPS/CG configuration may be transmitted with a priority indicator/index, and an MG configuration may also include a priority index for DCI-based scheduling (hereinafter, a first priority index) and a priority index for SPS/CG configuration (hereinafter, a second priority index). Upon receiving the DCI, the UE may compare the priority index in the DCI with the first priority index in the MG configuration for an MG that overlaps with transmission/reception scheduled by the DCI. Upon receiving the SPS/CG configuration, the UE may compare the priority index within the SPS/CG configuration with the second priority index. Then, the UE may determine whether to perform the transmission or reception scheduled within the MG. Even if the UE performs the transmission or reception within the MG, the UE may perform measurements in the MG period under the following conditions:
DL reception scheduled to be performed within the MG period, for example, PDCCH/PDSCH/CSI-RS reception; and/or
When the transmission/reception scheduled to be performed within the MG period does not overlap in time with a target (e.g., SSB) to be measured by the UE within the MG period.

The BS may operate by expecting/assuming that the UE will perform measurements within the MG under the above conditions and perform BS operations corresponding thereto.

### <Implementation 5: Ignore/Disable MG for DCI Scheduling Retransmission>

If the UE performs PDSCH reception or PUSCH transmission, the UE may expect to receive DCI scheduling retransmission for the corresponding reception/transmission (hereinafter, retransmission scheduling DCI) from the BS for a certain period of time after the corresponding reception/transmission. For example, after performing the PDSCH reception or PUSCH transmission, the UE may expect to receive the retransmission scheduling DCI while a DRX retransmission timer for a relevant HARQ process is running. In some scenarios, the DL DRX retransmission timer starts when a DL DRX HARQ Round Trip Time (RTT) timer expires. The DL DRX HARQ RTT timer starts in the first symbol after the UE transmits a NACK for the PDSCH reception. A UL DRX retransmission timer starts when a UL DRX HARQ RTT timer expires. The UL DRX HARQ RTT timer starts in the first symbol after the UE transmits the PUSCH. Each DRX retransmission timer stops when the UE detects the corresponding DL reception or UL transmission for the HARQ process. The values of the DL DRX HARQ RTT timer, DL DRX retransmission timer, UL HARQ RTT timer, and UL DRX retransmission timer may be provided by the BS to the UE through RRC signaling.

Alternatively, additional retransmission opportunities may be considered by taking into account the PDB of a TB transmitted on the PDSCH/PUSCH. For example, if the typical time required for retransmission is X ms, it may be determined whether additional retransmission is possible by considering the PDB of the TB. If the additional retransmission is possible, the UE may ignore an MG configuration and attempt to receive the PDCCH during an upcoming PDCCH monitoring occasion to receive the retransmission scheduling DCI from the BS, after responding with a NACK due to failure of DL reception of the TB or after performing the PUSCH transmission. Considering these cases, while the UE is expecting the retransmission scheduling DCI, if an MG period overlaps in time with the PDCCH monitoring opportunity, where the UE is capable of receiving the scheduling DCI, the UE may attempt the PDCCH monitoring and PDCCH reception without performing measurements during the MG period. In this case, not only the retransmission scheduling DCI but also other DCI may be monitored within the MG period. In some implementations, this operation may be limited to PDSCH reception and/or PUSCH transmission with the following characteristics. In other words, while the UE is waiting for retransmission scheduling DCI for the PDSCH reception and/or PUSCH transmission with the following characteristics, the UE may perform PDCCH monitoring at PDCCH monitoring occasion(s) that overlap with the MG, and the BS may perform PDCCH transmission at the PDCCH monitoring occasion(s).
A PDSCH/PUSCH carrying a TB with a PDB value smaller than a certain threshold (e.g., 10 ms) or a remaining PDB value. Information regarding the PDB may be provided from the BS to the UE through L2 signaling, or in the case of UL, the information may be provided from the UE to the BS. For example, in the case of UL, the UE may receive PDB information from the higher layers of the protocol stack thereof and forward the PDB information to the BS through an SR or a buffer status report (BSR). In the case of DL, the BS may receive PDB information from the higher layers of the protocol stack thereof and use DL assignment to share the information with the UE. The PDB information may be based on each logical channel at the MAC layer. For example, in the case of UL, the BS may configure the PDB for each logical channel, or the UE may provide the PDB when informing the BS of a logical channel or logical channel group of UL data that becomes available for transmission (e.g., through a BSR). Alternatively, when the UE informs the BS of the logical channel or logical channel group of the UL data that becomes available for transmission (e.g., through a BSR), the BS may provide a UL grant for the logical channel or logical channel group of the UL data to the UE along with the PDB. Alternatively, the PDB information may be based on TBs generated at the MAC layer, or the PDB information may be based on packets given from higher layers (e.g., RLC layer, PDCP layer, or application layer).
DCI indicating HP PUSCH transmission or HP PDSCH reception. For example, Implementation 5 may be used for reception opportunities and/or transmission opportunities scheduled by DCI or an SPS/CG configuration including a priority index greater than a certain threshold (e.g., 0). The threshold may be indicated via L1 signaling or higher layer signaling from the BS when the UE has three or more available priorities. If the UE has two available priorities, the threshold may be 0.
A PDSCH/PUSCH received/transmitted through an SPS/CG configuration.

In some implementations, the application of Implementation 5 may be limited to DL reception scheduling or UL transmission scheduling only. If Implementation 5 is limited to DL reception scheduling, the UE may not apply Implementation 5 when transmitting a HARQ-ACK responses for a PDSCH, which is received during a DL reception process, on a PUCCH/PUSCH. If Implementation 5 is limited to DL transmission scheduling, the BS may not apply Implementation 5 when receiving a HARQ-ACK response, which is transmitted during a DL transmission process, on a PUCCH/PUSCH.

In some implementations, the application of operations in Implementation 5 may vary for each G configuration. For example, only when the retransmission scheduling DCI overlaps with a specific MG, the UE may perform PDCCH monitoring at a PDCCH monitoring occasion that overlaps with the MG while expecting the retransmission scheduling DCI, without performing measurements on the MG. The specific MG may be determined based on the presence or absence of certain parameters in the MG configuration or by the values of certain parameters.

The implementations of the present disclosure described above may be applied individually or in combination of two or more.

According to some implementations of the present disclosure, a scheduling message or SPS/CG configuration that causes the UE to perform PDSCH/CSI-RS reception or PUCCH/PUSCH/SRS transmission within an MG may be provided to the UE, or a PDCCH scheduling/triggering the PDSCH/CSI-RS reception or PUCCH/PUSCH/SRS transmission may be provided to the UE within the MG. Accordingly, various resource allocation required for services with delay requirements may be provided to the UE even when there is an MG configuration. According to some implementations of the present disclosure, based on the MG configuration, the UE may be allowed to perform measurements while still receiving scheduling information or transmitting/receiving data/signals for services that meet specific conditions.

The UE may perform operations according to some implementations of the present disclosure in association with downlink signal reception. The UE may include at least one transceiver; at least one processor; and at least one computer memory operably connectable to the at least one processor and storing instructions that, when executed, cause the at least one processor to perform operations according to some implementations of the present disclosure. A processing device for a UE may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure. The computer program or the computer program product may be recorded in at least one computer-readable (non-transitory) storage medium and may include instructions that, when executed, cause (at least one processor) to perform operations according to some implementations of the present disclosure.

A method for the UE or the operations of the UE, processing device, computer-readable (non-transitory) storage medium, and/or computer program product may include: receiving an MG configuration; and based on an overlap between a MG according to the MG configuration and a DL reception occasion: i) based on specific conditions being not satisfied, performing measurements within the MG and omitting DL reception at the DL reception occasion within the MG; and ii) based on the specific conditions being satisfied, performing the DL reception at a DL reception occasion within the MG.

In some implementations, the specific conditions may include the following: the DL reception occasion is an SPS PDSCH occasion based on a specific SPS configuration, and the specific SPS configuration may be an SPS configuration with a priority index greater than a threshold or an SPS configuration with a value allowing SPS PDSCH reception at an SPS PDSCH occasion when the SPS PDSCH occasion overlaps with the measurement gap.

In some implementations, the specific conditions may include the following: the DL reception occasion is a PDCCH occasion based on a search space or CORESET configuration including a specific RRC parameter or a PDCCH monitoring occasion based on a search space configuration for a specific DCI format.

In some implementations, the MG configuration may include first priority information regarding scheduling based on DCI carried by a PDCCH and second priority information regarding scheduling based on RRC. The specific conditions may include the following: a priority configured by the first priority information within the MG configuration is smaller than a priority of the DL reception, based on the DL reception occasion being scheduled by a DCI format; and a priority configured by the second priority information within the MG configuration is smaller than the priority of the DL reception, based on the DL reception occasion being scheduled by an RRC message.

In some implementations, the specific conditions may include the following: the UE is waiting for DCI scheduling retransmission for a received PDSCH or a transmitted PUSCH; and the DL reception occasion is a PDCCH monitoring occasion.

In some implementations, the specific conditions may include the following: a TB carried by the PDSCH or the PUSCH has a packet data budget smaller than a specific threshold, is scheduled by a DCI format with a higher priority index value, or is based on an SPS configuration or a CG configuration.

In some implementations, the specific conditions may include the following: the DL reception occasion is scheduled by a DCI format with a higher priority index value, a DCI format indicating SPS activation, or a DCI format indicating the DL reception.

The BS may perform operations according to some implementations of the present disclosure in association with downlink signal transmission. The BS may include at least one transceiver; at least one processor; and at least one computer memory operably connectable to the at least one processor and storing instructions that, when executed, cause the at least one processor to perform operations according to some implementations of the present disclosure. A processing device for a BS may include at least one processor; and at least one computer memory operably connectable to the at least one processor and storing instructions that, when executed, cause the at least one processor to perform operations according to some implementations of the present disclosure. A computer readable (non-transitory) storage medium may store at least one computer program including instructions that, when executed by at least one processor, cause the at least one processor to perform operations according to some implementations of the present disclosure. A computer program or a computer program product may include instructions recorded in at least one computer readable (non-transitory) storage medium and causing, when executed, (at least one processor) to perform operations according to some implementations of the present disclosure.

A method for the BS or the operations of the BS, processing device, computer-readable (non-transitory) storage medium, and/or computer program product may include: transmitting an MG configuration; and based on an overlap between a MG according to the MG configuration and a DL transmission occasion: i) based on specific conditions being not satisfied, omitting DL transmission at the DL transmission occasion within the MG; and ii) based on the specific conditions being satisfied, performing the DL transmission at the DL transmission occasion within the MG.

In some implementations, the specific conditions may include the following: the DL transmission occasion is an SPS PDSCH occasion based on a specific SPS configuration, and the specific SPS configuration may be an SPS configuration with a priority index greater than a threshold or an SPS configuration with a value allowing SPS PDSCH transmission at an SPS PDSCH occasion when the SPS PDSCH occasion overlaps with the MG.

In some implementations, the specific conditions may include the following: the DL transmission occasion is a PDCCH occasion based on a search space or CORESET configuration including a specific RRC parameter or a PDCCH monitoring occasion based on a search space configuration for a specific DCI format.

In some implementations, the MG configuration may include first priority information regarding scheduling based on DCI carried by a PDCCH and second priority information regarding scheduling based on RRC. In some implementations, the specific conditions may include the following: a priority configured by the first priority information within the MG configuration is smaller than a priority of the DL transmission, based on the DL transmission occasion being scheduled by a DCI format; and a priority configured by the second priority information within the MG configuration is smaller than the priority of the DL transmission, based on the DL transmission occasion being scheduled by an RRC message.

In some implementations, the specific conditions may include the following: that the UE is waiting for DCI scheduling retransmission for a PDSCH or a PUSCH; and the DL transmission occasion is a PDCCH monitoring occasion.

In some implementations, the specific conditions may include that a TB carried by the PDSCH or the PUSCH has a packet data budget smaller than a specific threshold, is scheduled by a DCI format with a higher priority index value, or is based on an SPS configuration or a CG configuration.

In some implementations, the specific conditions may include that the DL transmission occasion is scheduled by a DCI format with a higher priority index value, a DCI format indicating SPS activation, or a DCI format indicating the DL transmission.

The examples of the present disclosure as described above have been presented to enable any person of ordinary skill in the art to implement and practice the present disclosure. Although the present disclosure has been described with reference to the examples, those skilled in the art may make various modifications and variations in the example of the present disclosure. Thus, the present disclosure is not intended to be limited to the examples set for the herein, but is to be accorded the broadest scope consistent with the principles and features disclosed herein.

The implementations of the present disclosure may be used in a BS, a UE, or other equipment in a wireless communication system.

1. A robot movement control method comprising:
receiving information about an objective location from a control server;
searching for a partial trajectory corresponding to a narrow section required for a robot to move from a current location to the objective location;
planning a partial global path for a non-narrow section required for the robot to move from the current location to the objective location by using a random tree method; and
generating a full global path for moving from the current location to the objective location by using the partial trajectory and the partial global path.

2. The robot movement control method of claim 1, further comprising preparing a partial trajectory for each of at least one narrow section.

3. The robot movement control method of claim 2, wherein the preparing of the partial trajectory includes:
extracting a plurality of nodes representing characteristics of the narrow section; and
generating a partial trajectory by connecting the plurality of nodes.

4. The robot movement control method of claim 3, wherein the preparing of the partial trajectory further includes modifying the partial trajectory to reflect the characteristics of the robot.

5. The robot movement control method of claim 4, wherein the characteristics of the robot include at least one of a shape, size, degree of freedom of movement, or rotation radius of the robot.

6. The robot movement control method of claim 1, wherein the partial trajectory is a one-way movement trajectory or a two-way movement trajectory.

7. The robot movement control method of claim 1, wherein the partial global path includes a first partial global path and a second partial global path, and
the full global path is generated such that one end of the partial trajectory is connected to a first partial global path and another end of the partial trajectory is connected to a second partial global path.

8. The robot movement control method of claim 1, further comprising:
checking availability of the searched partial trajectory with reference to an obstacle map;
based on the partial trajectory being available, generating the global path by using the partial trajectory; and
based on the partial trajectory not being available, determining whether an evasion path exists.

9. The robot movement control method of claim 8, further comprising:
based on existence of the evasion path, generating a new global path to include the evasion path; and
based on non-existence of the evasion path, notifying the control server that movement to the objective location is not possible.

10. The robot movement control method of claim 1, further comprising:
calculating a time period during which the robot passes through the narrow section based on the full global path; and
reserving the calculated time period for passage of the narrow section to the control server.

11. The robot movement control method of claim 10, further comprising:
based on the reserving being successful, the robot starting driving based on the full global path;
based on the reservation failing, modifying the partial global path to pass through the narrow section at another time period; and
generating a modified full global path by using the modified partial global path and the partial trajectory.

12. The robot movement control method of claim 11, further comprising reserving the other time period for passage of the narrow section to the control server.

13. The robot movement control method of claim 11, wherein the modified full global path is planned to pass through a waiting area before passing through the narrow section.

14. The robot movement control method of claim 13, further comprising, based on the robot approaching the narrow section before the other time period, waiting in the waiting area until the robot is capable of passing through the narrow section during the other time period.

15. The robot movement control method of claim 1, further comprising:
the robot receiving first local path information recommended for the robot by another robot and second local path information of the other robot;
based on the first local path information and the second local path information, the robot generating third local path information for the robot and fourth local path information for the other robot;
the robot transmitting the third local path information and the fourth local path information to the other robot; and
the robot driving based on third local path information.

16. The robot movement control method of claim 15, wherein the other robot is located within a predetermined distance from the robot.

17. The robot movement control method of claim 15, further comprising the robot generating an objective space based on obstacle information sensed by a sensing module of the robot, first local path information, obstacle map information, and second local path information,
wherein the third local path information is planned to minimize an additional burden cost based on the objective space.

18. A robot comprising:
a communication unit configured to communicate with a control server;
a moving unit configured to move the robot;
a sensing module configured to sense an object placed externally;
a map storage unit containing an obstacle map; and
a controller configured to receive information about an objective location from the control server, search for a partial trajectory corresponding to a narrow section required to move from a current location to the objective location, plan a partial global path for a non-narrow section required to move from the current location to the objective location by using a random tree method, and generate a full global path for moving from the current location to the objective location by using the partial trajectory and the partial global path.

19. The robot of claim 18, wherein a partial trajectory for each of at least one narrow section is prepared by one of the control server and the robot.

20. The robot of claim 18, wherein the partial global path includes a first partial global path and a second partial global path, and the controller performs control to generate the full global path such that one end of the partial trajectory is connected to a first partial global path and another end of the partial trajectory is connected to a second partial global path.
